(19) United States
(12) Patent Application Publication
(10) Pub. No.: US 2025/0143228 A1
(43) Pub. Date: May 8, 2025

(54) System for Optimizing Plant Growth and Plant Yield

(71) Applicants: David A. Metzger, Milwaukee, WI (US); Nasim Maghboli Balasjin, Milwaukee, WI (US)

(72) Inventors: David A. Metzger, Milwaukee, WI (US); Nasim Maghboli Balasjin, Milwaukee, WI (US)

(21) Appl. No.: 19/008,621

(22) Filed: Jan. 2, 2025

Related U.S. Application Data
(63) Continuation-in-part of application No. PCT/US2024/054477, filed on Nov. 4, 2024.
(60) Provisional application No. 63/547,141, filed on Nov. 2, 2023.

(51) Int. Cl. A01G 7/04; A01G 31/00; A01G 31/02

(52) U.S. Cl. CPC A01G 7/04; A01G 31/024; A01G 31/065; A01G 31/008

(57) ABSTRACT

A plant growing system having a growing chamber containing an aqueous growing medium and a growing atmosphere in which a plant is grown, a compound delivery system configured to deliver one or more compounds including nutrients mixed with surfactant into the growing atmosphere for plant stomatal uptake, an acoustical stimulation system configured to increase stomatal uptake, a growing medium oxygenation system configured for oxygenating, preferably hyperoxygenating or oxygen supersaturating, the growing medium which plant roots immersed therein take up oxygen longer before needing oxygen replenishment, and a plant lighting system configured to deliver ultraviolet wavelength filtered solar light to the plant for photosynthesis. The chamber preferably is a hyperbaric chamber, the growing atmosphere contains at least 0.06% carbon dioxide, the compounds are delivered in the form of atomized droplets, and the growing medium contains at least 2 mg/L oxygen in the form of nanobubbles diffused or dissolved therein.

### CROSS REFERENCE

This application is a continuation-in-part of International PCT Application No. PCT/US2024/54477 filed Nov. 4, 2024, and also claims priority in and the benefit of U.S. Application Ser. No. 63/547,141 filed Nov. 2, 2023, the entire disclosures of each of which are hereby expressly incorporated herein by reference.

### FIELD

The present invention relates generally to a system for growing plants and more particularly to a system of growing plants that optimizes plant growth and yield.

### BACKGROUND

The world's farmers face significant challenges in meeting the needs of a rapidly growing global population, which is expected to reach around 10 billion people by 2050. Food production will need to increase by roughly 70% to meet the anticipated demand, especially given the continued population growth in Asia and sub-Saharan Africa, where food requirements are projected to rise fastest. Yet, the capacity of farmers to feed the world is constrained by numerous factors, including climate change, land and water resource limits, while political and economic barriers continue to mount.

Agricultural productivity has grown considerably in past decades, but in many regions, such as sub-Saharan Africa, yields still fall short of their potential by about 50%. Boosting these yields will require novel technology, infrastructure, and sustainable farming practices, alongside major reductions in food waste, which currently affects nearly one-third of global food production. Climate change presents another complication, with altered weather patterns, rising carbon dioxide levels and extreme events affecting crop viability in vulnerable areas. To adapt, farmers will need access to novel technologies, that increase yield while decreasing our carbon footprint.

Even more critically, food distribution inefficiencies and food access disparities are problematic. When, not if, global food supplies rise, issues like urbanization, regional import dependencies, and unequal access to nutritious food can still lead to mass hunger and malnutrition. Novel technologies aimed at improving the shelf life of fruits and vegetables, especially in low-income nations, are essential to prevent food shortages and mass starvation.

We are losing our available farming land. Desert expansion is occurring globally, accelerated by both natural climate patterns and human-induced climate change. For example, the Sahara Desert in Africa has grown by about 10% since 1920, largely driven by changes in rainfall patterns and an intensified warming trend.

Globally, other deserts are also likely to be growing as these processes widen subtropical dry zones, contributing to a broader trend in desertification that affects arable land and could challenge agricultural productivity. In regions like the Sahel, the advancing Sahara is pushing southward, disrupting ecosystems and water sources like Lake Chad, which has drastically shrunk over the last several decades. This expansion represents a significant environmental and socio-economic challenge, especially for communities dependent on stable climates and water resources for agriculture and livelihood in semi-arid regions near deserts. Deserts for the most part are unusable areas of earth devoid of the capability to support meaningful farming.

Interestingly, significant groundwater reservoirs, known as aquifers, exist beneath many of the world's major deserts, providing substantial water resources despite these regions' arid conditions. For instance, beneath the Sahara Desert, the Nubian Sandstone Aquifer System spans areas of Egypt, Sudan, Libya, and Chad, holding an estimated 150,000 cubic kilometers of ancient groundwater.

Each year, approximately 14% of global food is lost between harvest and the retail. This significant portion of our food supply is affected by factors like inadequate storage, poor handling during transportation, and lack of refrigeration, particularly impacting perishable items like fruits and vegetables. Losses during transit are especially high in lower-income regions, where infrastructure for cold storage and efficient transport is limited. For example, in regions of Asia, food losses during transport alone can reach as much as 20%.

On a global scale, food loss during transit is a significant contributor to overall food waste, costing billions if not trillions in lost economic value and exacerbating environmental impacts due to the resources required for food production, such as water and energy. Efforts to reduce these losses include improving logistics, packaging solutions, and temperature control technologies to better preserve food quality throughout the supply chain.

Ultimately, while it's possible to feed the growing population, this will require comprehensive changes to food systems, infrastructure, and policies to make food production sustainable and equitable. Failure to address these issues could limit farmers' ability to meet global food demands in the long term. Addressing these needs is seen as a priority by organizations such as the UN and FAO, which emphasize sustainable practices to safeguard future food security.

The extension of the shelf life of fruits and vegetables is a significant concern in the food industry due to their highly perishable nature. There is a need for a plant growing system that not only can reduce food shrinkage (waste) but be able to grow food under the desert surface.

### SUMMARY

The present invention is directed to a preferred system and method for growing plants that increases the rate or speed of germination, increases the rate, magnitude and size of plant growth, increases the yield, magnitude and size of yield, and/or increase plant life, plants, such as preferably beans and/or tomatoes, are hydroponically grown in a pressurized growing chamber, preferably a hyperbaric chamber, in a carbon dioxide rich pressurized atmosphere, an oxygen-saturated liquid hydroponic medium, and using stomatal feeding with nebulized liquid nutrients, e.g., liquid fertilizers, delivered to the stomata's of the plants while being subjected to optimized frequency auditory vibrations that enhances nebulized nutrient intake into the stomata's of the plants.

In a preferred method and system, the pressurized growing chamber is a hyperbaric chamber configured to pressurize the growing atmosphere within the chamber to a pressure of at least 0.15 MPa, preferably at least 0.2 MPa and more preferably at least about 0.3 MPa. In one such preferred method and system, the pressurized growing chamber is a hyperbaric chamber configured to pressurize the growing atmosphere within the chamber to a pressure of at least 0.15 MPa, preferably at least 0.2 MPa and more preferably at least about 0.3 MPa and no more than 0.5 MPa as it facilitates increased plant growth especially when done in conjunction with a CO2 enhanced chamber growing atmosphere.

Using a hyperbaric plant growing chamber with a CO2 rich growing atmosphere pressurized to about 0.3 MPa, a standard bean plant will grow about 10 times the size of a standard bean plant in the same amount of time. Such a CO2 rich growing atmosphere preferably contains at least 0.06%, preferably at least about 0.08%, and more preferably at least 0.1% CO2. In at least one preferred method and system for growing plants in accordance with the present invention, the pressurized growing atmosphere within the chamber is composed substantially completely of CO2 and is pressurized to a pressure of at least 0.15 MPa, preferably at least 0.2 MPa atmospheres and more preferably at least about 0.3 MPa and no more than 0.5 MPa as it facilitates increased plant growth as discussed elsewhere herein.

This floods the plant's environment with CO2 with the hyperbaric pressure driving the CO2 into the cells of the plants thereby increasing the rate and amount of CO2 intake by each plant. Drives the CO2 into the plants at the cellular level. May regrow plant telomeres. Plants will not only grow faster but live longer and provide a greater yield for a longer period of time. This optimizes photosynthesis. Note that when plants are at germination stage, the plants need oxygen to develop shoots and root. Therefore, from seed to germination stage, oxygen is required for seeds to sprout and develop into a seedling.

In the air, there is only about 0.02% to 0.04% CO2 in the earth's atmosphere. In the invention, at least 0.06%, preferably at least about 0.08%, and more preferably at least 0.1% of CO2 are in the pressurized atmosphere within the growing chamber that is pressurized to a pressure of at least 0.15 MPa, preferably at least 0.2 MPa and more preferably at least 0.3 MPa to optimize germination, growth, and yield. In at least one preferred method and system for growing plants in accordance with the present invention, the pressurized growing atmosphere within the chamber is composed substantially completely of CO2 and is pressurized to a pressure of at least 0.15 MPa, preferably at least 0.2 MPa and more preferably at least about 0.3 MPa and no more than 0.5 MPa as it facilitates increased plant growth as discussed elsewhere herein. By increasing atmospheric pressure within the growing chamber, CO2 intake and the rate of CO2 intake by the plant are increased thereby increasing the rate of CO2 diffusion from the pressurized atmosphere into the plant through the stomata of the leaves and stem of each plant in the growing chamber.

In addition to providing a pressurized growing atmosphere with an increased amount of CO2 (enhanced CO2 growing atmosphere or enhanced CO2 growing environment), fruit or vegetables grown under such a high pressure growing atmospheric environment are advantageously subjected to hyperbaric ripening extending treatment while the plant and its fruit and/or vegetables are still growing and before harvest. In a preferred method and system, an on-plant high pressure ripening extending treatment, aka on-plant high-pressure spoilage delaying treatment, occurs as a result of the actual produce of the plants being grown in a high-pressure growing atmosphere environment where the growing atmosphere within the chamber to a pressure of at least 0.15 MPa, preferably at least 0.2 MPa and more preferably at least about 0.3 MPa and no more than 0.5 MPa. Subjecting the produce, e.g., fruit and/or vegetables, growing on plants, from seedling stage, within the high-pressure growing atmosphere within the growing chamber not only increases produce growth, produce growth rate, increases the speed of maturity, reduces the number of days until mature, increases plant yield, but also treats the produce in a manner that delays spoilage by producing hardier spoilage resistant produce.

In a preferred method and system, subjecting the produce, e.g., fruit and/or vegetables, growing on plants within the high-pressure growing atmosphere within the growing chamber at least doubles the amount of time after harvest before picked/harvested produce begins to spoil compared to produce from the same type of plant(s) conventionally grown outdoors in Earth's atmosphere at normal atmospheric pressure of one atmosphere. In another preferred method and system, subjecting the produce, e.g., fruit and/or vegetables, growing on plants within the high-pressure growing atmosphere within the growing chamber at least doubles the amount of time after harvest before picked/harvested produce actually spoils compared to produce from the same type of plant(s) conventionally grown outdoors in Earth's atmosphere at normal atmospheric pressure of one atmosphere.

In another preferred method and system, subjecting the produce, e.g., fruit and/or vegetables, growing on plants within the high-pressure growing atmosphere within the growing chamber at least triples the amount of time after harvest before picked/harvested produce begins to spoil compared to produce from the same type of plant(s) conventionally grown outdoors in Earth's atmosphere at normal atmospheric pressure of one atmosphere. In another preferred method and system, subjecting the produce, e.g., fruit and/or vegetables, growing on plants within the high-pressure growing atmosphere within the growing chamber at least triples the amount of time after harvest before picked/harvested produce actually spoils compared to produce from the same type of plant(s) conventionally grown outdoors in Earth's atmosphere at normal atmospheric pressure of one atmosphere.

In a preferred method and system, a nebulizer is configured to discharge nano-sized liquid droplets containing one or more liquid nutrients therein, such as one or more liquid nutrients of or in a fertilizer that has been solubilized in an aqueous delivery vehicle, e.g., water. These nano-sized liquid nutrient-containing droplets form a nebulized cloud that travels within the pressurized growing atmosphere within the growing chamber until at least some of the nutrient-containing droplets in the cloud come in contact with stomata of the leaves and stems of the plants within the growing chamber thereafter being drawn therein and preferably passing there through during plant respiration.

In another preferred method and system, a nebulizer is further configured to discharge nano-sized nutrient particles, e.g., fertilizer particles, into a nebulized cloud whose nanosized nutrient particles have a size of between 1 nm and about 100 nm and travel within the pressurized growing atmosphere inside the growing chamber until at least some of the nanosized nutrient particles come in contact with stomata of the leaves and stems of the plants within the growing chamber thereafter being drawn therein and preferably passing therethrough during plant respiration.

In still another preferred method and system, a nebulizer is further configured to discharge both nanosized nutrient particles, e.g., fertilizer particles, and nanosized droplets containing one or more nutrients, e.g., one or more fertilizers, into a nebulized cloud whose nanosized nutrient particles and nanosized nutrient droplets travel within the pressurized growing atmosphere inside the growing chamber until at least some of the nanosized nutrient particles and/or and nanosized nutrient droplets come in contact with stomata of the leaves and stems of the plants within the growing chamber thereafter being drawn therein and preferably passing therethrough during plant respiration.

In one such preferred system and method, the pressurized growing chamber is disposed underground and any equipment, e.g., pumps, solenoids, valves, gates, etc., are powered using above-ground solar power or solar energy which can be in the form of a liquid sodium, e.g., sodium salt, solar power or solar energy plant. In one such preferred system and method, the pressurized growing chamber is disposed underground at a depth deep enough to provide a constant temperature growing environment.

In one preferred method and system, the growing chamber is disposed underground in a desert, such as preferably the Sahara Desert or the Gobi Desert, at a depth of at least 10 feet, preferably at least 15 feet underneath the surface of the desert, and in the vicinity of an underground aquifer at a depth deeper than the growing chamber. In one such method and system composed of at least a plurality of pairs, i.e., at least three, of the pressurized growing chambers, each growing chamber is disposed underground at a constant temperature depth of at least 10 feet, preferably at least 15 feet, underneath the surface of the desert and which also is disposed above, preferably overlying, an aquifer from which water for the hydroponic aqueous growing medium is provided.

In a preferred system and embodiment, each growing chamber is disposed at a depth below the desert surface of at least 10 feet, preferably at least 15 feet, more preferably at least 20 feet, and even more preferably at least 25 feet, that provides a growing temperature within the chamber of between 21° and 32° Celsius. In another preferred system and embodiment, each growing chamber is disposed at a depth below the desert surface of at least 10 feet, preferably at least 15 feet, more preferably at least 20 feet, and even more preferably at least 25 feet, that provides a growing temperature of between 25° and 30° Celsius. In still another preferred system and embodiment, each growing chamber is disposed at a depth below the desert surface of at least 10 feet, preferably at least 15 feet, more preferably at least 20 feet, and even more preferably at least 25 feet, that provides a growing temperature of about 22°±5° Celsius.

Using a hyperbaric plant growing chamber with an enhanced CO2 or CO2 rich growing atmosphere pressurized to about three atmospheres, a standard bean plant will grow about 10 times the size of a standard bean plant in the same amount of time. Such a CO2 rich growing atmosphere preferably contains at least 0.06%, preferably at least about 0.08%, and more preferably at least 0.1% CO2. This floods the plant's environment with CO2 with the hyperbaric pressure driving the CO2 into the cells of the plants thereby increasing the rate and amount of CO2 intake by each plant. Drives the CO2 into the plants at the cellular level. May regrow plant telomeres. Plants will not only grow faster but live longer and provide a greater yield for a longer period of time. This optimizes photosynthesis.

In the air, there is only about 0.02% to 0.04% CO2 in the earth's atmosphere. In the invention, at least 0.06%, preferably at least about 0.08%, and more preferably at least 0.1% of CO2 are in the pressurized atmosphere within the growing chamber that is pressurized to a pressure of at least 0.15 MPa, preferably at least 0.2 MPa and more preferably at least 0.3 MPa to optimize germination, growth and yield. By increasing atmospheric pressure within the growing chamber, CO2 intake and the rate of CO2 intake by the plant are increased thereby increasing the rate of CO2 diffusion from the pressurized atmosphere into the plant through the leaves and stem of the plant.

In the case of gas absorption by plants, diffusion occurs from an area of higher gas concentration (outside the plant, in the atmosphere) to an area of lower gas concentration (inside the plant, within the leaf cells). This movement of gases is driven by the concentration gradient, with gases naturally moving from regions of higher concentration to lower concentration until equilibrium is reached.

In a preferred method and system, a plant grown in a pressurized growing chamber in an enhanced CO2 atmosphere containing increased CO2 levels compared to the earth's atmosphere helps lengthen plant life compared to the life of the same plant grown in the earth's atmosphere containing normal CO2 levels. A plant irradiated with photons from intermediate wavelength light free of IR and UV rays prevents plant cell telomerase/telomere damage from occurring. In another preferred method and system, a plant irradiated with photons from intermediate wavelength light free of IR and UV rays enables growth or lengthening of plant cell telomerase/telomeres during the life of the plant.

In a preferred method and system, a light filter is employed that blocks infrared (IR) and/or ultraviolet (UV) rays from reaching plants in the growing chamber. In one such preferred embodiment, a light filter composed of acrylic or an acrylic material is used to block IR wavelengths or IR light, which is cell damaging, and UV wavelengths or UV light, which is DNA destabilizing. If an acrylic filter is used, it will block IR rays thereby preventing IR cell damage, and also block UV rays, thereby preventing DNA damage. What remains after IR and UV filtering are photons at intermediate wavelengths sufficient to cause plant photosynthesis to occur without IR cell damage and UV DNA damage occurring to the plants in the growing chamber. Because these plants in the growing chamber are not subjected to cell-damaging IR and DNA damaging UV rays from the sun, plant life is significantly extended. In one method and system, plant life is extended by at least 25%, preferably by at least 40%, more preferably by at least 60%, and even more preferably by at least 80% compared to the life of a plant of the same variety grown outdoors under natural sunlight and rooted in soil. In another method and system, plant life is at least doubled, preferably is at least tripled, while preferably is at least quadrupled, and even more preferably is increased by at least five times compared to the life of a plant of the same variety grown outdoors under natural sunlight and rooted in soil.

In a preferred method and system, a plant irradiated with photons from intermediate wavelength light free of IR and UV rays has at least twice the lifespan compared to the life of the same plant grown in full sunlight without any IR and UV ray filtering. In another preferred method and system, a plant irradiated with photons from intermediate wavelength light free of IR and UV rays has at least three times the life compared to the same plant grown in full sunlight without any IR and UV ray filtering. In yet another preferred method and system, a plant irradiated with photons from intermediate wavelength light free of IR and UV rays has at least four times the life compared to the same plant grown in full sunlight without any IR and UV ray filtering. In still another preferred method and system, a plant irradiated with photons from intermediate wavelength light free of IR and UV rays has at least five times the life compared to the same plant grown in full sunlight without any IR and UV ray filtering. In a further preferred method and system, a plant irradiated with photons from intermediate wavelength light free of IR and UV rays can live indefinitely or can live forever and preferably lives indefinitely or lives forever compared to the same plant grown in full sunlight without any IR and UV ray filtering.

In a preferred method and system, a plant irradiated with photons from intermediate wavelength light free of IR and UV rays prevents plant cell telomerase/telomere damage from occurring thereby preventing plant cell telomerase/telomeres from shortening in length. In another preferred method and system, a plant irradiated with photons from intermediate wavelength light free of IR and UV rays enables growth or lengthening of plant cell telomerase/telomeres during the life of the plant. With just these factors being used to carry out germination and growth of a bean plant, the bean plant germinated more quickly and grew more quickly growing to a height of four and a half to five inches compared to a bean plant grown in a normal unpressurized atmospheric environment in outdoor light containing IR and UV rays that had only sprouted in the same amount of time.

It is contemplated that a method and system of the present invention is particularly well suited for indoor farming, underground farming and even preferably underground desert farming, such as in the Sahara Desert or Mojave Desert. Underground desert farming is preferred because plants can be grown in growing chambers of the present invention located underground at a depth where the temperature remains stable, such as at about 22 degrees Celsius, all year round. There also is an underground aquifer underneath both the Sahara Desert and the Mojave Desert from which water could be delivered to the plants in an underground growing chamber of the present invention. Preferably, the water from any underground aquifer in the desert can be used to provide in part or in whole an aqueous liquid growing medium used for hydroponically growing one or more plants in the growing chamber.

Hyperbaric hydroponic underground farming. Light is filtered using an IR filter and a UV filter or a combination IR and UV light filter to selectively filter out at least those IR and UV light wavelengths which are harmful to the plant. In one preferred method and system, the filter or filters filter out all IR and UV light from the light being provided to irradiate the plant for photosynthesis. The photons of the light remaining after IR and UV filtering are delivered through fiber optic cable to each plant in the growing chamber thereby illuminating or irradiating the shoots, e.g., leaves and stems, of each plant providing photons at IR and UV safe wavelengths to each plant. Sunlight can be gathered above-ground, UV and IR filtered before being delivered via a light transmitting cable, such as a fiber optic filaments and/or cables, or a light transmitting conduit of different construction to the plant or plants in the growing chamber.

The plants in a growing chamber of the present invention are grown in a hydroponic hyperbaric pressurized CO2 enhanced growing atmosphere growing chamber. The roots are at least partially immersed in a liquid growing medium that preferably is an aqueous liquid growing medium. Preferably no soil whatsoever is used. The aqueous hydroponic liquid growing medium, such as preferably water, e.g., distilled or purified water, is oxygenated, preferably hyper-oxygenated, to saturate oxygen in the aqueous hydroponic liquid growing medium that stimulates root growth and preferably also helps enable full root immersion of the roots of the plant in the oxygenated aqueous hydroponic liquid growing medium. The oxygenated aqueous hydroponic liquid growing medium preferably is hyper-oxygenated by being substantially completely saturated with oxygen, such as in the form of oxygen (O₂) or ozone (O₃). In addition, hyper-oxygenated aqueous hydroponic liquid growing medium enables the root system of the plants in the growing chamber to more efficiently, preferably more rapidly, uptake nutrients, including minerals, in solution in the aqueous hydroponic liquid growing medium thereby further increasing the rate and/or speed of germination, post-germination plant growth, rate of root growth, amount of root mass, along with increasing plant yield.

In a preferred method of hyper-oxygenating the aqueous hydroponic liquid growing medium, such as preferably water, e.g., initially distilled water or purified water, e.g., water purified such as by reverse osmosis filtering, charged nebulization is used together with a source of high pressure oxygen forming oxygen nanobubbles or oxygen-carrying nanobubbles that are nanosized bubbles having a diameter of between 1 nm and about 100 nm with a significant zeta potential that enables the oxygen to stay saturated in the aqueous hydroponic liquid growing medium for at least one week, preferably at least a plurality of weeks, more preferably at least a plurality of pairs of, i.e., at least three, weeks, and even more preferably at least four weeks, e.g., at least one month, before the aqueous hydroponic liquid growing medium needs to be re-oxygenated. In a preferred method and system of hyper-oxygenating the aqueous hydroponic liquid growing medium, pressurized oxygen having a pressure of at least 15 PSI, preferably at least 20 PSI, more preferably at least 30 PSI, even more preferably at least 40 PSI, still even more preferably at least 60 PSI, yet even more preferably at least 80 PSI and still even yet more preferably at least 100 PSI is passed through a charged nebulizer configured to impart a charge thereto to produce charged oxygen nanobubbles and/or oxygen-carrying nanobubbles discharged from the nebulizer into the aqueous hydroponic liquid growing medium thereby hyper-oxygenating the aqueous hydroponic liquid growing medium preferably causing the oxygen to go into solution. In one such preferred method and system of hyper-oxygenating the aqueous hydroponic liquid growing medium, pressurized oxygen having a pressure of at least 15 PSI, preferably at least 20 PSI, more preferably at least 30 PSI, even more preferably at least 40 PSI, still even more preferably at least 60 PSI, yet even more preferably at least 80 PSI and still even yet more preferably at least 100 PSI, is passed through a charged nebulizer configured to impart a charge to the oxygen nanobubbles and/or oxygen-carrying nanobubbles discharged from the nebulizer into the aqueous hydroponic liquid growing medium thereby hyper-oxygenating the aqueous hydroponic liquid growing medium causing the aqueous hydroponic liquid growing medium to become super-saturated with oxygen. In a preferred method and system, the oxygen nanobubbles and/or oxygen-carrying nanobubbles remain in the form of oxygen nanobubbles and/or oxygen-carrying nanobubbles after hyper-oxygenation is performed.

This nebulization method and nebulizer system, e.g., nebulizer, preferably charged nebulizer, of the present invention advantageously enables oxygen super saturation of the aqueous hydroponic liquid growing medium in a manner such that the oxygen stays in solution in the aqueous hydroponic liquid growing medium at least one week, preferably at least a plurality of weeks, more preferably at least a plurality of pairs of, i.e., at least three, weeks, and even more preferably at least one month. In a preferred nebulization method and nebulizer system, oxygen remains supersaturated in the aqueous hydroponic liquid growing medium for at least one week, preferably at least a plurality of weeks, more preferably at least a plurality of pairs of, i.e., at least three, weeks, and even more preferably at least one month before needing to be recharged using the nebulization method and nebulizer system of the present invention. In another preferred nebulization method and nebulizer system, oxygen remains supersaturated in the aqueous hydroponic liquid growing medium for at least one week, preferably at least a plurality of weeks, more preferably at least a plurality of pairs of, i.e., at least three, weeks, and even more preferably at least one month before the amount or level of oxygen in solution in the aqueous hydroponic liquid growing medium drops by no more than 10% from the original amount of the oxygen in the supersaturated aqueous hydroponic liquid growing medium solution after supersaturating nebulization was first carried out.

In yet another preferred nebulization method and nebulizer system, oxygen remains supersaturated in the aqueous hydroponic liquid growing medium for at least one week, preferably at least a plurality of weeks, more preferably at least a plurality of pairs of, i.e., at least three, weeks, and even more preferably at least one month before the amount or level of oxygen in solution in the aqueous hydroponic liquid growing medium drops by no more than 25% from the original amount of the oxygen in the supersaturated aqueous hydroponic liquid growing medium solution after supersaturating nebulization was initially carried out. In yet still another preferred nebulization method and nebulizer system, oxygen remains supersaturated in the aqueous hydroponic liquid growing medium for at least one week, preferably at least a plurality of weeks, more preferably at least a plurality of pairs of, i.e., at least three, weeks, and even more preferably at least one month before the amount or level of oxygen in solution in the aqueous hydroponic liquid growing medium drops by no more than 35% from the original amount of the oxygen in the supersaturated aqueous hydroponic liquid growing medium solution after supersaturating nebulization was initially carried out. In a further preferred nebulization method and nebulizer system, oxygen remains supersaturated in the aqueous hydroponic liquid growing medium for at least one week, preferably at least a plurality of weeks, more preferably at least a plurality of pairs of, i.e., at least three, weeks, and even more preferably at least one month before the amount or level of oxygen in solution in the aqueous hydroponic liquid growing medium drops by no more than 45% from the original amount of the oxygen in the supersaturated aqueous hydroponic liquid growing medium solution after supersaturating nebulization was initially carried out.

The use of a supersaturated oxygen aqueous hydroponic liquid growing medium solution advantageously enables at least two-thirds, preferably at least three-quarters, more preferably at least 85%, even more preferably at least 90%, and still even more preferably substantially completely all of the root system of the plants in the growing chamber to be immersed therein without plant degradation occurring during plant germination and/or during the plant growing phase. The use of a supersaturated oxygen aqueous hydroponic liquid growing medium solution advantageously enables at least two-thirds, preferably at least three-quarters, more preferably at least 85%, even more preferably at least 90%, and still even more preferably substantially completely all of the root system of the plants in the growing chamber to be submerged in the supersaturated oxygen aqueous hydroponic liquid growing medium solution. Doing so advantageously enables the oxygen needs of each plant in the growing chamber to be satisfied by being taken up via the plant's root system such as preferably through the roots of the plant. By being to immerse a greater amount or percentage of the plant's root system in the hyper-oxygenated aqueous hydroponic liquid growing medium, it enables a greater amount and rate of oxygen uptake do occur for each plant in the growing chamber thereby helping to increase the speed and rate of germination, increase the rate of root growth and amount of root mass, increase the rate of growth and shoot mass, decrease the time to maturity, and/or increase the amount of plant produce yielded compared to a conventionally grown plant of the same variety not grown in a hyper oxygenated aqueous hydroponic liquid growing medium.

By supersaturating the aqueous hydroponic liquid growing medium with oxygen, it also enables the roots of the plants to more efficiently and more rapidly take up nutrients, including fertilizer(s), in solution in the aqueous hydroponic liquid growing medium thereby increasing the rate of root growth, increasing root mass growth, increasing root mass, increasing the rate of plant growth, increasing plant growth, increasing plant mass, as well as increasing the rate of growth of produce, e.g., fruits and/or vegetables, of each plant in the growing chamber.

The present method and system of the invention also contemplates that the growing method and system is carried out in a closed cycle system where water respirated from the plants and water evaporated from the hydroponic pool in which the root system is at least partially submerged is condensed and recycled to the hydroponic pool for continued hydroponic growing of the plants in the closed system chamber.

The source or supply of CO2 provided to the pressurized hyperbaric plant growing atmosphere in the plant chamber preferably is harvested from the atmosphere preferably by stripping the CO2 out of the atmosphere using one or more known CO2 carbon capture systems and methods. In a preferred method and system, carbon dioxide is captured and/or converted through a single electrochemical process that involves using an electrode to attract carbon dioxide released from a CO2-capturing sorbent that then is converted into a reduced, reusable form, e.g., liquid CO2 and/or CO2 gas. In another preferred method and system, carbon dioxide is captured by passing air through a stack of charged electrochemical plates, preferably electrodes, which have each plate or electrode coated with a carbon-dioxide adsorbent compound exhibiting an affinity for carbon dioxide, such as preferably polyanthraquinone which has been composited with carbon nanotubes. The stack of charged electrochemical plates, preferably electrodes, operates as a battery during which carbon dioxide is adsorbed by the carbon-dioxide adsorbing coated plates or electrodes during charging of the battery which is then discharged during discharging of the battery. Other forms and types of carbon capturing and sequestration techniques can be used to capture carbon dioxide, including from the air, smokestacks, combustion discharges, and the like for use with increasing the amount of CO2 in the pressurized atmosphere within the growing chamber.

In a preferred method and system of the present invention, the system and method is a negative net carbon system and method that uses more carbon, in the form of CO2, than what the system and method is generating. In other words, a growing chamber constructed and operated in accordance with present invention with plants growing therein is configured to operate as a negative net carbon system by using more CO2 than the amount of CO2 that the growing chamber of the present invention produces. In a preferred method and system of the present invention, the carbon is captured by stripping CO2 from the atmosphere and delivered in one of a liquid and gaseous form to the growing chamber. The amount of CO2 delivered to the chamber is regulated to ensure that a desired amount of CO2 is present in the pressurized growing atmosphere within the chamber to achieve at least 0.06%, preferably at least about 0.08%, and more preferably at least 0.1% in the pressurized growing atmosphere within the chamber. Excess CO2 is stored, such as in cylinders or tanks, providing a CO2 reserve that enables CO2 to be delivered any time to the growing chamber when needed to keep the growing atmosphere in the chamber supplied with at least 0.06%, preferably at least about 0.08%, and more preferably at least 0.1% in the pressurized growing atmosphere within the chamber.

Each growing chamber of the present invention can be a part of a group of growing chambers of a grow system of the present invention whose electrically powered components, such as pumps, solenoids, valves, etc. preferably can be powered using solar power. In one preferred method and system, all of the power needed to run such a multiple growing chamber system could be provided by a sodium liquid salt solar generation such that conventional solar panels are not needed. All of the growing chambers are essentially big sealed and pressurized boxes that can be placed underground. Since it is a hydroponic operation, the water used during hydroponic growing operation can be returned to the aquifer from which all or part of the hydroponic water was obtained if desired. If desired, water used as aqueous hydroponic liquid growing medium can even be recycled and recirculated. In another preferred method and system, water can be filtered after hydroponic use, such as by using a multilayer sand charcoal filter, enabling the water to be reused in the hydroponic operation resulting in a closed hydroponic water circulation system.

Also during germination and growth, plants in the growing chamber of the present invention are exposed to auditory vibrations, such as preferably music, at optimal frequencies to facilitate earlier germination such as by earlier opening of the stomata, increased rate of plant growth, and even nutrient, e.g., fertilizer, uptake.

In a preferred plant growing and plant growth enhancing method and system of the present invention, nutrients are administered within the growing atmosphere using stomatal feeding where plant nutrients, including fertilizer(s), are delivered via nebulization. In such a preferred method and system, a nebulizer is used to nebulize liquid nutrients, preferably fertilizer(s), into a nutrient, preferably fertilizer, containing mist in the growing atmosphere which reaches and preferably contacts the leaves and stems of the plants in the growing chamber. The nutrient-containing, preferably fertilizer-containing, droplets in the mist enter the plants in the chamber via the stomata of the plants thereby more rapidly and efficiently providing nutrients, preferably fertilizer(s), to the plants via atmospheric stomatal feeding.

In one preferred method and system, nutrients are administered to the plants using a nebulizer or nebulizer system while the plants are being exposed to auditory stimulation by being exposed to optimal frequency auditory vibrations, such as preferably in the form of music, more preferably classical music. In such a preferred method and system, liquid nutrients are conveyed through a nebulizer into the pressurized atmosphere within the growing chambers under optimal frequency auditory stimulation to induce uptake of the nebulized nutrients through the stomata of the leaves and the stem of each plant. Use of optimal frequency enhanced nebulization has been found to cause plants to more efficiently increase their intake of nutrients more optimally than nutrient uptake via the plants root system. This causes nebulized nutrients to be taken up more quickly through the plant's leaves and stem as compared to being taken up through the root system.

As such, the present invention is directed to a method and system of growing plants utilizing a closed growing system employing a pressurized growing chamber in which plants are stomatically fed using liquid nutrient nebulization in an enhanced CO2 pressurized atmosphere, watered using an oxygen saturated aqueous hydroponic liquid medium without any soil that is at least a carbon neutral, preferably carbon negative, system and method.

### DESCRIPTION OF THE DRAWINGS

One or more preferred exemplary embodiments of the invention are illustrated in the accompanying drawings in which like reference numerals represent like parts throughout and in which:

FIG. 1 is a diagram depicting a plant growing system of the present invention illustrating a growing chamber in which plants are received which has a pressurized growing atmosphere in which foliage of each plant is immersed, is irradiated with light from a plant lighting system, a first bioactive component stomatal delivery system, a growing medium in which a root system of each plant is disposed, an oxygenation system that oxygenates the growing medium to provide oxygen to roots of the plants, a second bioactive component growing medium delivery system, and an acoustic plant stimulation system that sonically stimulates the plants.

FIG. 2A presents an enlarged first portion of the diagram of FIG. 1 illustrating in more detail the growing medium oxygenation system configured to oxygenate, preferably with nanosized oxygen nanobubbles, the growing medium in the chamber in which the root systems of the plants in the chamber are immersed.

FIG. 2B presents an enlarged second portion of the diagram of FIG. 1 illustrating in more detail the growing chamber, the bioactive component stomatal delivery system, the plant lighting system, the bioactive component growing medium delivery system, and the acoustic stimulation system.

FIG. 3 is an enlarged front elevation view of the growing chamber.

Before explaining one or more embodiments of the invention in detail, it is to be understood that the invention is not limited in its application to the details of construction and the arrangement of the components set forth in the following description and illustrated in the drawings. The invention is capable of other embodiments or being practiced or carried out in various ways. Also, it is to be understood that the phraseology and terminology employed herein is for the purpose of description and should not be regarded as limiting.

### DETAILED DESCRIPTION

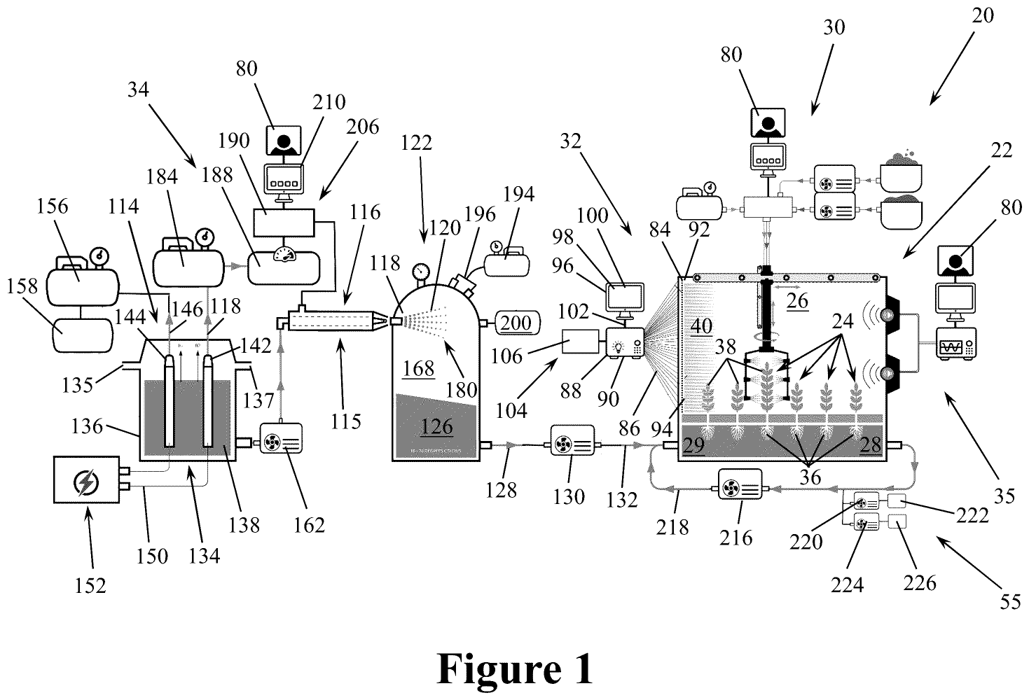

FIG. 1 illustrates a plant growing system 20 of the present invention that includes a plant growing chamber 22 in which one or more plants 24 are disposed in at least a growing atmosphere 26 and preferably also in a growing medium 28, a first plant compound delivery subsystem 30 configured to deliver via the growing atmosphere 26 and/or stomatal uptake one or more compounds that are preferably bioactive compounds to one or more of the plants 24 in the chamber 22, a plant lighting subsystem 32 configured to deliver light to one or more of the plants 24 in the chamber 22, an oxygenating subsystem 34 configured to provide oxygen to one or more plants 24 in the chamber 22, a second plant compound delivery subsystem 55 configured to deliver via the growing medium 28 and/or root uptake one or more compounds that are preferably also bioactive compounds to one or more of the plants 24 in the chamber 22, and which preferably can also include an acoustic stimulation subsystem 35 configured to provide sonic stimulation to one or more plants 24 in the chamber 22 during one or more of the seedling stage, vegetative growth stage, flowering or budding stage, pollination and/or fertilization stage, fruiting/seed formation stage, ripening and/or maturation stage, and/or senescence and/or dormancy or death stage(s) of plant growth of the plants 24 growing in the chamber 22.

The growing system 20 can and preferably also includes acoustic plant stimulation subsystem 35 configured to subject the plant 24, preferably at least part of its shoot system 45, including at least part of its foliage 38, to sonic stimulation during one or more of the seedling stage, vegetative growth stage, flowering or budding stage, pollination and/or fertilization stage, fruiting/seed formation stage, ripening and/or maturation stage, and/or senescence and/or dormancy or death stage(s) of plant growth. In a preferred embodiment and method, the acoustic plant stimulation subsystem 35 is configured to acoustically stimulate one or more plants 24 in the chamber 22 to open their stomata or open their stomata wider to deliver or apply and/or during application of one or more bioactive compounds to the stomata of the plants 24 by the first plant compound delivery subsystem 30 during a bioactive compound application cycle, e.g., a stomatal nutrient feeding cycle.

The growing system 20 utilizes a growing method of the present invention where a plant 24 grown in the chamber 22 is subjected to a pressurized growing atmosphere 26 that contains a greater percentage of carbon dioxide than in the Earth's atmosphere through which delivery of one or more compounds, such as preferably one or more bioactive compounds, to at least part of the shoot system 45, including at least part of the foliage 38, of the plant 24, preferably through uptake through at least a plurality of the stomata of the shoot system 45, including stomata of the foliage 38 and stem(s) 54, of the plant 24, is carried out using compound delivery subsystem 30 while at least a portion of the roots 36 of a root system 37 of the plant 24, preferably substantially all of the roots 36 of the root system 37 of the plant 24, are disposed in an oxygenated growing medium 28 oxygenated by the oxygenating subsystem 34 while the chlorophyll-containing foliage 38 of the plant 24 is subjected to light 40 from the plant lighting subsystem 32 which irradiates the plant 24 with light 40 in the visible spectrum which is substantially free from any ultraviolet light during one or more of the seedling stage, vegetative growth stage, flowering or budding stage, pollination and/or fertilization stage, fruiting/seed formation stage, ripening and/or maturation stage, and/or senescence and/or dormancy or death stage(s) of plant growth. The use of a pressurized growing atmosphere 26 inside the chamber 22 not only facilitates increased growth and greater yields of the plants 24 but pressurizing the growing atmosphere 26 to a pressure substantially greater than atmospheric pressure advantageously helps increase uptake of compounds delivered via the growing atmosphere 26 to the plants 24, preferably to be taken up by their stomata, from the compound delivery subsystem 30, increasing the growth rate, growth and yields of the plants 24. Where equipped with an acoustic plant stimulation subsystem 35, the acoustic stimulation subsystem 35 preferably is configured to acoustically stimulate one or more plants 24 in the chamber 22 in a manner that not only can also increase the growth rate, growth and yields of the plants 24 but which preferably also can be configured to acoustically stimulate stomata of the plants 24 to open or increase the size of their openings to facilitate uptake of bioactive compounds delivered by the compound delivery subsystem 34 into the growing atmosphere 26 surrounding one or more of the plants 24 growing in the chamber 22 causing the bioactive compounds to be taken up by the stomata of the plants 24 in the chamber 22.

As discussed in more detail below, a plant growing system 20 configured and carried out in accordance with a method of growing plants 24 of the present invention using such a system 20 advantageously produces plants 24 which grow faster, produce more vegetation, reach the flowering or budding stage more quickly, produces edible produce, in the form of edible fruit, edible vegetable(s), edible root(s), edible stem(s), edible leaves, edible seed(s), edible tuber(s) and/or edible bulbs, more quickly in greater amounts, i.e., produces larger yields, while retaining edible produce freshness longer, and/or which also delays plant senescence which can advantageously enable plants 24 to grow edible produce longer, have a greater number of edible produce harvests, and/or contribute to producing greater yields of edible produce for an extended period of time compared to the same types or strains of plants conventionally grown hydroponically or outdoors in soil in the Earth's atmosphere at an ambient pressure of approximately 1 atmosphere, 101.3 kilopascals (kPa), or 14.7 pounds per square inch (psi).

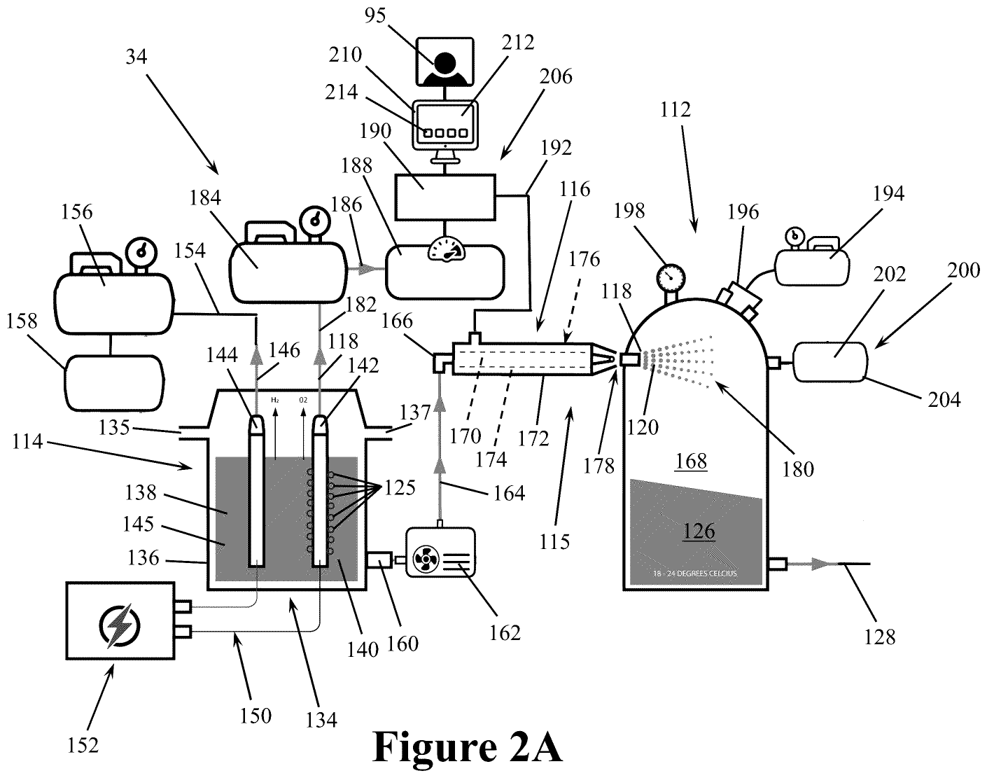

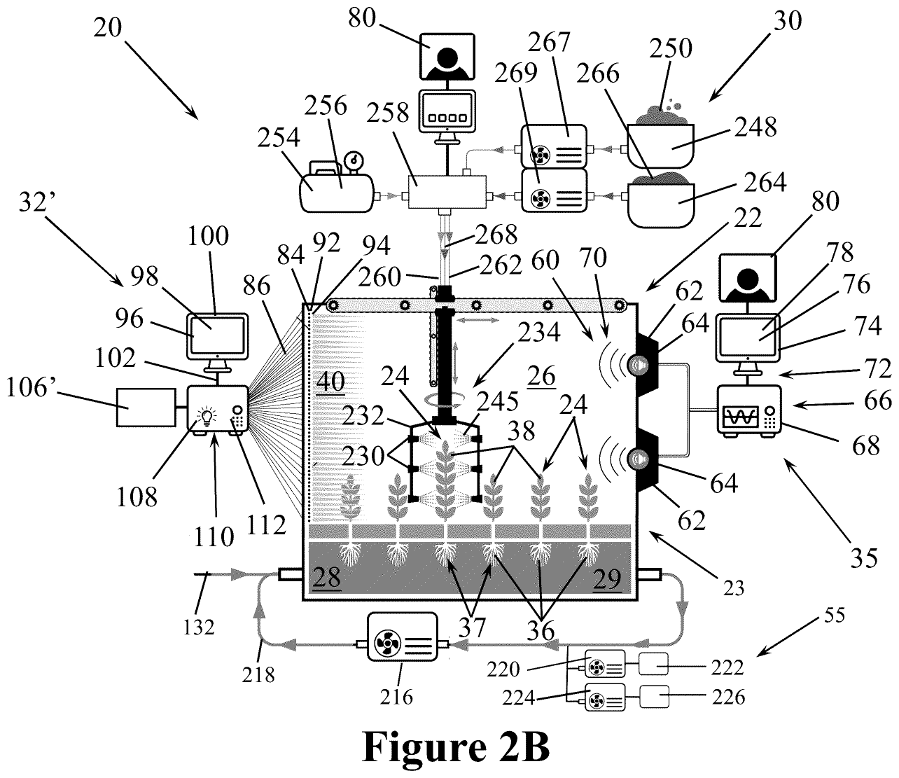

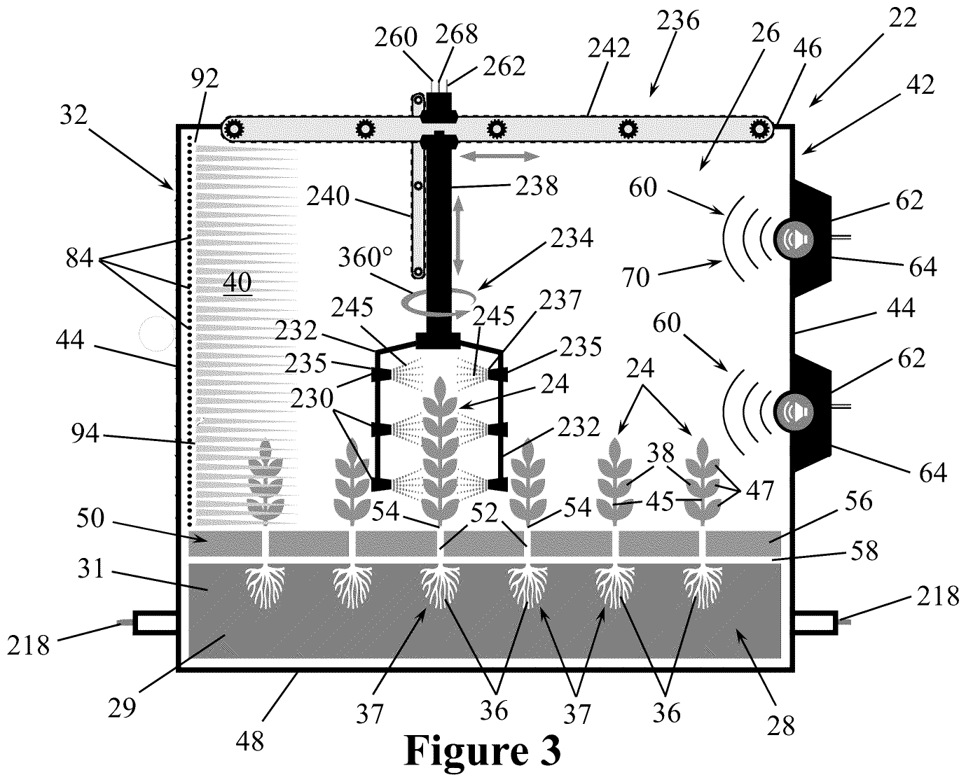

With additional reference to FIGS. 2A, 2B and 3, the growing chamber 22 has an enclosure 42 that houses at least the growing atmosphere 26 and preferably also houses the growing medium 28 with the growing atmosphere 26 disposed or arranged above the growing medium 28. While the growing chamber enclosure 42 is configured to hold a plurality of spaced apart plants 24, it is contemplated that the growing chamber 22 and/or its enclosure 42 can be constructed and arranged to hold only a single plant 24 if desired. As discussed below, growing chamber 22 preferably is of gas-tight construction, e.g., is gas tight or gas-tightly sealed, to hold a gaseous growing atmosphere that is pressurized to a pressure greater than atmospheric pressure. Where the growing chamber 22 is also configured to hold the growing medium 28, the growing chamber 22 preferably is of growing medium impermeable construction such as by being of liquid-tight construction, e.g., is liquid-tight, fluid-tight, water-tight, liquid-tightly sealed, fluid-tightly sealed, or water-tightly sealed, where the growing medium 28 is a liquid, viscous fluid, a slurry, a colloid, an emulsion, a suspension, or a gel. A preferred growing medium 28 is a dispersion 29 that preferably is a hydroponic growing medium 31 that more preferably is a hydroponic dispersion, such as a hydroponic liquid, a hydroponic slurry, a hydroponic colloid, a hydroponic emulsion, a hydroponic suspension, a hydroponic gel or another type of hydroponic dispersion where the hydroponic liquid, hydroponic slurry, hydroponic colloid, hydroponic emulsion, hydroponic suspension, hydroponic gel or other type of hydroponic dispersion is formulated with enough water, preferably at least 15% by weight, to produce a hydroponic dispersion configured to ensure nutrient and oxygen uptake through the roots, support photosynthesis, maintain turgor, facilitate temperature regulation and/or regulate temperature, and support the metabolism and metabolic processes of the plant 24. Where the growing medium 28 is a gel or liquid having a high enough viscosity of at least 5000 centipoise, preferably at least 10,000 centipoise, and more preferably at least 25,000 centipoise, such a thicker or high enough viscosity growing medium 28 is configured to help uprightly self-support the plants 24 in the chamber 22 by anchoring roots 36 of each plant 24 in the growing medium 28.

The enclosure 42 of the growing chamber 22 is gas-tightly sealed to configure the growing chamber 22 to hold a growing atmosphere 26 in which the plant 24 is grown that is pressurized to a pressure greater than atmospheric pressure that preferably is pressurized to a pressure of at least 150 kPa (about 1.5 atmospheres (atm)), preferably at least 200 kPa (about 2 atm), more preferably at least 400 kPa (about 4 atm), even more preferably at least about 600 kPa (about 6 atm), and yet even more preferably at least about 800 kPa (about 8 atm) and preferably no greater than about 1000 kPa (about 10 atm) and more preferably no greater than 1500 kPa (about 15 atm) during one or more of, preferably a plurality at least a plurality of, more preferably at least a plurality of pairs, i.e., at least three, of, and even more preferably each one the seedling stage, vegetative growth stage, flowering or budding stage, pollination and/or fertilization stage, fruiting/seed formation stage, ripening and/or maturation stage, and/or senescence and/or dormancy or death stage(s) of plant growth of at least one plant 24 grown in the enclosure 42 of the growing chamber 22 advantageously causing an increase in one or more of the growth rate of the plant 24, the vegetation growth rate of the plant 24, produce more vegetation on the plant 24, cause the plant 24 to reach the flowering or budding stage more quickly, cause the plant 24 to produce edible produce more quickly and in greater amounts, i.e., produces larger yields, while retaining edible produce freshness longer, and/or which also delays senescence of the plant 24 which can advantageously enable the plant 24 to grow edible produce longer, have a greater number of edible produce harvests, and/or contribute to the plant 24 producing greater yields of edible produce for an extended period of time compared to the same type or strain of the plant conventionally grown hydroponically or outdoors in soil in the Earth's atmosphere at an ambient pressure of approximately 1 atmosphere, 101.3 kilopascals (kPa), or 14.7 pounds per square inch (psi). In one such preferred plant growing system embodiment and implementation of a plant growing method of the present invention, the pressurized growing atmosphere 26 inside the chamber 22 is a carbon dioxide rich or carbon dioxide enhanced growing atmosphere 44 that contains a greater percentage of carbon dioxide than the Earth's atmosphere with a preferred pressurized growing atmosphere 26 containing at least 0.06% carbon dioxide, preferably at least 0.08% carbon dioxide and more preferably at least about 0.1% carbon dioxide during one or more of the seedling stage, vegetative growth stage, flowering or budding stage, pollination and/or fertilization stage, fruiting/seed formation stage, ripening and/or maturation stage, and/or senescence and/or dormancy or death stage(s) of plant growth of at least one plant 24 grown in the growing chamber 22 advantageously causing an increase in one or more of the growth rate of the plant 24, the vegetation growth rate of the plant 24, produce more vegetation on the plant 24, cause the plant 24 to reach the flowering or budding stage more quickly, cause the plant 24 to produce edible produce more quickly and in greater amounts, i.e., produces larger yields, while retaining edible produce freshness longer, and/or which also delays senescence of the plant 24 which can advantageously enable the plant 24 to grow edible produce longer, have a greater number of edible produce harvests, and/or contribute to the plant 24 producing greater yields of edible produce for an extended period of time compared to the same type or strain of the plant conventionally grown hydroponically or outdoors in soil in the Earth's atmosphere at an ambient pressure of approximately 1 atmosphere, 101.3 kilopascals (kPa), or 14.7 pounds per square inch (psi). In another such preferred embodiment and method implementation, the pressurized growing atmosphere 26 within the chamber 22 contains at least about 0.06% carbon dioxide and no more than about 0.4% carbon dioxide, preferably contains between about 0.06% carbon dioxide and about 0.3% carbon dioxide, more preferably contains between about 0.06% carbon dioxide and about 0.2% carbon dioxide, and even more preferably contains between about 0.06% carbon dioxide and about 0.15% carbon dioxide and which growing atmosphere 26 is pressurized above atmospheric pressure to one or more of the aforementioned pressures listed above in this paragraph and/or a pressure falling within one of the aforementioned pressure ranges listed above in this paragraph. In one preferred plant growing system embodiment and plant growing method implementation of the present invention, the pressure of the growing atmosphere 26 inside the chamber 22 is pulsed while being maintained at a pressure above atmospheric pressure, such as at one or more of the aforementioned pressures listed above in this paragraph and/or a pressure falling within one of the aforementioned pressure ranges listed above in this paragraph with the growing atmosphere pressure pulses helping to facilitate and preferably increase the rate of vegetative feeding, preferably stomatal feeding, of the plant 24 growing in the chamber 22. In one such preferred embodiment and method implementation, the growing atmosphere 26 is a carbon dioxide rich or carbon dioxide enhanced growing atmosphere containing a percentage of carbon dioxide in the growing atmosphere 26 that is greater than or equal to one of the aforementioned minimum carbon dioxide percentages listed above in this paragraph and/or which falls within one of the carbon monoxide percentage ranges listed above in this paragraph, which is pressurized above atmospheric pressure to one or more of the aforementioned pressures or minimum pressures listed above in this paragraph and/or a pressure falling within one of the aforementioned pressure ranges listed above in this paragraph, and which is subjected to pressure pulses or pressure pulsing. In yet another preferred embodiment and method implementation, the growing atmosphere 26 is pressurized to at least about 300 kPa and no more than about 600 kPa and contains at least 0.06% carbon dioxide, preferably at least 0.08% carbon dioxide, and more preferably at least 0.1% carbon dioxide which causes a standard bean plant grown in the chamber 22 in such a pressurized carbon dioxide rich growing atmosphere 26 to grow to a size that is at least 8 times the size of the same standard bean plant conventionally grown in soil in the Earth's atmosphere at atmospheric pressure of about 101 kPa (about 1 atm) and which preferably grows to a size of about 10 times the size of the same standard bean plant conventionally grown in soil in the Earth's atmosphere at atmospheric pressure. During the ripening and/or maturation stage of the plant 24 when the edible food product grown by the plant is ripening and/or maturing, the growing atmosphere 26 within the growing chamber 22 can be and preferably is composed substantially completely of carbon dioxide, e.g., about 100% carbon dioxide, and which can also be pressurized to a pressure above atmospheric pressure that preferably is at least 125 kPa, more preferably is at least 150 kPa, even more preferably is at least 200 kPa, and which still even more preferably is at least 300 kPa, and which is no greater than about 1500 kPa, preferably is no greater than about 1000 kPa, and which more preferably is no greater than about 600 kPa to sterilize unharvested edible produce of the plant 24 while in the chamber 22 and which can also preserves the edible produce of the plant 24 in a manner that advantageously selectively delays ripening, prevent spoilage, and extend the shelf life of the edible produce after it is harvested from the plant 24 and removed from the chamber 22. Such a growing atmosphere 26 composed substantially completely of carbon dioxide and which can be pressurized to a have a minimum pressure or a pressure falling within a pressure range in accordance with the pressures and/or pressure ranges disclosed hereinabove can be maintained during the senescence and/or dormant stage(s) of the plant 24 in the case where the plant 24 remains in the chamber 22 and the edible produce of the plant 24 remains on or with the plant 24 during the senescence and/or dormant stage(s) to continue to sterilize the edible produce of the plant 24 and/or to continue to preserve the edible viability of the edible produce of the plant 24 should the edible produce of the plant 24 be unharvested during the senescence and/or dormant stage(s) of the plant 24.

After the ripening and/or maturation stage of the plant 24 when the edible food product grown by the plant has fully ripened and/or fully matured and before harvest therefrom by removal or detachment from the plant 24, the growing atmosphere 26 within the growing chamber 22 can be and preferably also is composed substantially completely of carbon dioxide, e.g., about 100% carbon dioxide, and which can also be pressurized to a pressure above atmospheric pressure that preferably is at least 125 kPa, more preferably is at least 150 kPa, even more preferably is at least 200 kPa, and which still even more preferably is at least 300 kPa, and which is no greater than about 1500 kPa, preferably is no greater than about 1000 kPa, and which more preferably is no greater than about 600 kPa to sterilize unharvested edible produce of the plant 24 while in the chamber 22 and which can also preserves the edible produce of the plant 24 in a manner that advantageously selectively delays ripening, prevent spoilage, and extend the shelf life of the edible produce after it is harvested from the plant 24 and removed from the chamber 22. Such a growing atmosphere 26 composed substantially completely of carbon dioxide and which can be pressurized to a have a minimum pressure or a pressure falling within a pressure range in accordance with the pressures and/or pressure ranges disclosed hereinabove can be maintained during the senescence and/or dormant stage(s) of the plant 24 in the case where the plant 24 remains in the chamber 22 and the edible produce of the plant 24 remains on or with the plant 24 during the senescence and/or dormant stage(s) to continue to sterilize the edible produce of the plant 24 and/or to continue to preserve the edible viability of the edible produce of the plant 24 should the edible produce of the plant 24 be unharvested during the senescence and/or dormant stage(s) of the plant 24

Such a growing chamber 22 constructed in accordance with the present invention preferably is a hyperbaric plant growing chamber 23 having a gas-tight, liquid-tight enclosure 42 which at least holds the pressurized growing atmosphere 26, preferably a carbon dioxide rich or carbon dioxide enhanced growing atmosphere 26, having a percentage of carbon dioxide greater than the Earth's atmosphere that is greater than or equal to one of the aforementioned minimum carbon dioxide percentages disclosed above in the preceding paragraph(s) and/or found elsewhere herein, and/or which falls within one of the carbon monoxide percentage ranges listed in the preceding paragraph(s) and/or disclosed elsewhere herein, and which is pressurized above atmospheric pressure to a pressure at or above one or more of the aforementioned pressures disclosed in the preceding paragraph(s) and/or found elsewhere herein and/or to a pressure falling within one of the aforementioned pressure ranges listed the preceding paragraph(s) and/or disclosed elsewhere herein. In one such preferred embodiment and method implementation, at least a plurality of plants 24 are grown in in the chamber 22 under such a high-pressure growing atmosphere 26 that preferably is carbon dioxide rich or carbon dioxide enhanced high pressure growing atmosphere 26 that can be and more preferably also is a pulsed carbon dioxide rich/carbon dioxide enhanced high pressure growing atmosphere 26 having pressures and carbon dioxide percentages in accordance with those disclosed above and/or elsewhere herein. In such a pulsed pressure method of operation, the pressure of the growing atmosphere 26 in the chamber 22 is pulsed such as to encourage stomata of the plants 24 to open or open wider in preparation for and/or during a bioactive compound application cycle using compound delivery subsystem 30.

With specific reference to FIGS. 2B and 3, the growing chamber 22 is configured to at least hold the growing atmosphere 26 and the shoot system 45, including foliage 38 of each plant 24 in the chamber 22, and which can be and preferably also is configured to hold the growing medium 28 in which the roots 36 of each plant 24 in the chamber 22 are received. The growing chamber enclosure 42 preferably has at least one sidewall 44 and preferably has at least one of a top wall 46 and/or a bottom wall 48. In the preferred growing chamber embodiment shown in FIGS. 2B and 3, the enclosure 42 as a plurality of sidewalls 44, a top wall 46 which overlies the foliage 38 of each plant 24, and a bottom wall 48 which underlies the growing medium 28 and roots 36. If desired, enclosure 42 can have a generally square or generally rectangular in cross-section and can be square, e.g., a cube or cubical, or rectangular like the square or rectangular enclosure 42 shown in FIGS. 2B and 3. One or more walls 44, 46, and/or 48 of the enclosure 42 can be composed of plastic, metal, glass, or another suitable material. In addition to the enclosure 42 being gas tight, the walls 44, 46, and/or 48 can be optically opaque so as to substantially completely prevent light transmission therethrough. If desired, enclosure 42 can also be configured to prevent transmission of sound delivered into the enclosure 42 by the acoustic stimulation system through the enclosure 42 to the exterior of the enclosure 42, such as by the enclosure 42 and/or one or more of the enclosure walls 44, 46 and/or 48 being of sound dampening, sound absorbing, sound attenuating, vibration deadening, and/or vibration isolating construction.

With continued reference to FIGS. 2B and 3, there preferably is a barrier 50 in the chamber 22 that is disposed between the growing atmosphere 26 and the growing medium 28, which has openings 52 through which extends at least part of a stem 54 of each plant 24 in the chamber 24. Barrier 50 can be configured to at least partially support each plant 24 being grown in chamber 22 and preferably is configured to substantially equidistantly space the plants 24 apart from one another. Barrier 50 preferably also is configured to separate the gaseous growing atmosphere 26 from the growing medium 28 in a manner that prevents any gas or gases in the growing atmosphere 26 from diffusing into the growing medium 28. Where the growing medium 28 is a dispersion 29, such as a hydroponic dispersion, which preferably is a hydroponic growing medium 31, the barrier 50 is a gas-impermeable barrier that is configured to prevent any gas or gases in the growing atmosphere 26 from diffusing into water in the growing medium 28, preferably dispersion 29, more preferably hydroponic growing medium 31, disposed in the chamber 22 beneath the barrier 50. In one embodiment, the barrier 50 is a gas-tight or gas-impermeable membrane 56 that extends between the sidewalls 44 of the growing chamber enclosure 42, which can be attached to or seal with the sidewalls 44 of the enclosure 42 in a manner that is gas-tight or forms a gas-tight seal with the enclosure sidewalls 44. In one such embodiment, the gas-tight or gas-impermeable membrane 56 can be of flexible construction, such as by being made of plastic or the like, and/or configured to float on the surface 58 of the growing medium 28.

It is an advantage of such a growing chamber 22 constructed, arranged and configured in accordance with the present invention because it can be placed underground in a preferred method of subterranean hyperbaric carbon dioxide assisted farming of the present invention that not only can reduce food shrinkage (waste) but which can be used to grow food under the desert surface preferably by locating the growing chamber 22 at a depth of at least 15 meters, preferably at least 20 meters and more preferably at least 25 meters underground that advantageously provides a substantially constant temperate in the chamber 22 of between about 20° and about 32° Celsius. The use of a hyperbaric carbon dioxide (CO2) rich growing atmosphere 26 in the growing chamber 22 advantageously extends the shelf life of fruits and vegetables grown by plants 24 in the chamber 22 by creating an environment that slows down microbial growth, plant respiration, and the ripening processes.

As previously discussed, a preferred growing medium 28 is a dispersion 29 that preferably is a hydroponic growing medium 31, that more preferably is a hydroponic dispersion, such as a hydroponic liquid, a hydroponic colloid, a hydroponic emulsion, a hydroponic slurry, a hydroponic suspension, a hydroponic gel or another type of hydroponic dispersion where the hydroponic liquid, hydroponic colloid, hydroponic emulsion, hydroponic slurry, hydroponic suspension, hydroponic gel or other type of hydroponic dispersion is formulated with enough water, preferably at least 15% by weight, to produce a hydroponic dispersion that configures the hydroponic dispersion with enough water to ensure nutrient uptake through the roots 36, support plant photosynthesis, maintain plant turgor, facilitate temperature regulation and/or regulate temperature of the plants 24, and support the metabolism and metabolic processes of the plants 24. Where the growing medium 28 is a gel or liquid having a high enough viscosity of at least 5000 cP, preferably at least 10,000 cP, and more preferably at least 25,000 cP, such a thicker or high enough viscosity growing medium 28 is configured to help enable the plants 24 to uprightly support themselves in the chamber 22 by stably and preferably firmly anchoring the roots 36 of each plant 24 in the high-viscosity plant-supporting growing medium 28.

As also shown in FIGS. 2B and 3, the growing chamber 22 can be and preferably is configured with an acoustic stimulator 60 of an acoustic stimulation subsystem 35 of the present invention that is configured to provide acoustic or sonic stimulation to the plants 24 growing in the chamber 22 in the form of acoustical energy, e.g., sound, during at least one or more of the seedling stage, vegetative growth stage, flowering or budding stage, pollination and/or fertilization stage, fruiting/seed formation stage, ripening and/or maturation stage, and/or senescence and/or dormancy or death stage(s) of plant growth of plants 24 in the chamber 22. With specific reference to FIG. 2B, a preferred acoustic stimulator 60 is composed of at least one and preferably a plurality of transducers 62 carried by the chamber 22 which are preferably spaced apart speakers 64 in acoustic communication with the chamber 22 which are each driven by an acoustic or sound generation subsystem 66, which can be or include a tone generator 68, configured to cause the transducers 62, preferably speakers 64, to deliver acoustic stimulation to the plants 24 in the chamber 22 in the form of acoustic energy 70, preferably soundwaves 70, outputted thereby that travel through the growing atmosphere 26 to impinge against and at least partially be absorbed by the shoot systems 45, including the foliage 38, of the plants 24 growing in the chamber 22.

The sound waves 70 emitted from the transducers 62, preferably speakers 64, have a preferred desired frequency, plurality of desired frequencies, desired range of frequencies, or range of desired frequencies selected and/or configured to stimulate and preferably increase growth of the plants 24 in the chamber 22 during at least one or more of the seedling stage, vegetative growth stage, flowering or budding stage, pollination and/or fertilization stage, fruiting/seed formation stage, ripening and/or maturation stage, and/or senescence and/or dormancy or death stage(s) of plant growth of the plants 24 in the chamber 22. Exposure of the plants 24 in the chamber 22 to acoustic stimulation with acoustic energy 70 in accordance with that discussed herein during at least the germination and growth stages advantageously stimulates the plants 24 into early germination during the germination stage, opening of the stomata of the plants 24 and/or early opening of plant stomata during the germination stage and/or growth stage, increased growth during at least the growth stage, and/or increased nutrient uptake during at least the germination stage and/or growth stage.

The acoustic or sound generation subsystem 66 can include or be controlled by an acoustic or sound generation controller 72 that is or includes a processor equipped computing device 74, such as a computer, e.g., notebook computer, desktop computer or workstation, a mobile computing device, such as a tablet or smart phone, or another computing device 74 that preferably is configured in software and/or firmware to control operation of one or both of the transducers 62, preferably speakers 64, and/or tone generator 68 to cause the transducers 62, preferably speakers 64, to output a desired frequency, plurality of desired frequencies, desired range of frequencies, or range of desired frequencies selected and/or configured to stimulate and preferably increase growth of the plants 24 in the chamber 22 during at least one or more of the seedling stage, vegetative growth stage, flowering or budding stage, pollination and/or fertilization stage, fruiting/seed formation stage, ripening and/or maturation stage, and/or senescence and/or dormancy or death stage(s) of plant growth of the plants 24 in the chamber 22. The controller 72, preferably computing device 74, can be configured in software and/or firmware with a user interface 76 that is displayable on a screen 78 thereof which in turn is configured in software and/firmware executed by the controller 72, preferably computing device 74, to enable a user 80 to make changes to an acoustic or sound generation program or algorithm implemented in software and/or firmware on board the controller 72, preferably computing device 74, that enables the user 80 to control the frequency, frequencies, and/or range of frequencies, time duration(s) and/or amplitude(s), e.g. decibel level or sound pressure level, thereof of sound emitted by the transducers 62, preferably speakers 64, into the chamber 22 during acoustic stimulation of the plants 24.

The sound pressure level of the acoustical energy 70, preferably tone(s), outputted by the transducers 62, preferably loudspeakers 64, that the plants 24 are subjected to preferably is between about 50 decibels and about 110 decibels, preferably between 70 decibels and 100 decibels, and preferably does not exceed 115 decibels under any circumstances. In a preferred embodiment and method implementation, the sound pressure level of the acoustical energy 70, preferably tone(s), outputted by the transducers 62, preferably loudspeakers 64, encountered by the plants 24 is between 70 decibels and 110 decibels, preferably is between about 70 decibels and about 90 decibels.

In a preferred acoustic or sound generation subsystem embodiment and implementation of an acoustic stimulation method of the present invention, the acoustic stimulator 60, preferably controller 72, is configured to cause the transducers 62, preferably speakers 64, to output acoustical energy in the form of a sound that that can be and preferably is a continuous tone having a single frequency of between about 4000 Hz and about 6000 Hz, preferably between 4000 and 6000 Hz, for a predetermined period of time of at least 1 minute, preferably at least 2 minutes, more preferably at least 5 minutes, even more preferably at least 10 minutes, and yet even more preferably at least 15 minutes but no more than 20 or 30 minutes during each hour every hour during at least one or more of one or more of the seedling stage, vegetative growth stage, flowering or budding stage, pollination and/or fertilization stage, fruiting/seed formation stage, ripening and/or maturation stage, and/or senescence and/or dormancy or death stage(s) of plant growth of the plants 24 growing in the chamber 22. In one preferred acoustic or sound generation subsystem embodiment and implementation of an acoustic stimulation method of the present invention, the acoustic stimulator 60, preferably controller 72, is configured to cause the transducers 62, preferably speakers 64, to output acoustical energy 70 in the form of a sound 70 that that can be and preferably is a continuous tone having a single frequency of between about 4000 Hz and about 6000 Hz, preferably between 4000 and 6000 Hz, for a predetermined period of time of at least about 1 minute and no more than about 5-7 minutes, preferably at least about 2 minutes and no more than about 7-10 minutes, more preferably at least about 5 minutes and no more than about 10-12 minutes, even more preferably at least about 10 minutes and no more than about 15 minutes, and yet even more preferably at least about 15 minutes and no more than about 20 minutes each hour every hour during at least one or more of one or more of the seedling stage, vegetative growth stage, flowering or budding stage, pollination and/or fertilization stage, fruiting/seed formation stage, ripening and/or maturation stage, and/or senescence and/or dormancy or death stage(s) of plant growth of the plants 24 growing in the chamber 22. The acoustic or sound generation subsystem 66, preferably controller 72, can be configured to thereafter cease the delivery of all acoustical energy to the plants 24 in the chamber 22 for a predetermined period of time of between about 2 minutes and about 15 minutes before the sequence of delivering or outputting acoustical energy disclosed in the first sentence and/or second sentence of this paragraph is repeated. The acoustic or sound generation subsystem 66, preferably controller 72 can be further configured to alternate between cycles where the acoustical energy 70 is delivered to the plants 24 in the chamber 22 in accordance with that disclosed in this paragraph and then paused by ceasing output or delivery of the acoustical energy 72 the plants 24 in the chamber 22 in accordance with that also disclosed in this paragraph.

In such an embodiment and method implementation, acoustic or sound generation subsystem 66, preferably controller 72, is configured to cause the transducers 62, preferably speakers 64, to output acoustical energy 70, such as in the form of a tone that preferably is a continuous tone having a single frequency of about 4000 Hz, preferably exactly 4000 Hz, for a predetermined period of time of at least 5 minutes, preferably at least 10 minutes, and more preferably at least 15 minutes and no more than about 20 minutes, preferably for a duration of no more than about 5 to 10 minutes beyond the time which the acoustical energy 70 was first outputted, each hour every hour during at least one or more of one or more of the seedling stage, vegetative growth stage, flowering or budding stage, pollination and/or fertilization stage, fruiting/seed formation stage, ripening and/or maturation stage, and/or senescence and/or dormancy or death stage(s) of plant growth of the plants 24 in the chamber 22. The acoustic or sound generation subsystem 66, preferably controller 72, can be configured to thereafter cease the delivery of all acoustical energy to the plants 24 in the chamber 22 for a predetermined period of time of between 2 minutes and 10 minutes before the sequence of delivering or outputting acoustical energy disclosed in the first sentence of this paragraph is repeated. The acoustic or sound generation subsystem 66, preferably controller 72 can be further configured to alternate between cycles where the acoustical energy 70 is delivered to the plants 24 in the chamber 22 in accordance with that disclosed in this paragraph and then paused by ceasing output or delivery of the acoustical energy 72 the plants 24 in the chamber 22 in accordance with that also disclosed in this paragraph.

In another such embodiment and method implementation, acoustic or sound generation subsystem 66, preferably controller 72, is configured to cause the transducers 62, preferably speakers 64, to output a tone that preferably is a continuous having a single frequency of about 4000 Hz, preferably exactly 4000 Hz, for a predetermined period of time of at least 5 minutes, preferably at least 10 minutes, and more preferably at least 15 minutes and no more than about 20 minutes during each hour every hour during at least one or more of one or more of the seedling stage, vegetative growth stage, flowering or budding stage, pollination and/or fertilization stage, fruiting/seed formation stage, ripening and/or maturation stage, and/or senescence and/or dormancy or death stage(s) of plant growth of the plants 24 in the chamber 22. In another such embodiment and method implementation, acoustic or sound generation subsystem 66, preferably controller 72, is configured to cause the transducers 62, preferably speakers 64, to output a tone that preferably is a continuous having a single frequency of about 5000 Hz, preferably exactly 5000 Hz, for a predetermined period of time of at least 5 minutes, preferably at least 10 minutes, and more preferably at least 15 minutes each hour every hour of one or more desired stages of growth of the plants 24 in the chamber 22. In yet another such embodiment and method implementation, acoustic or sound generation subsystem 66, preferably controller 72, is configured to cause the transducers 62, preferably speakers 64, to output a tone that preferably is a continuous having a single frequency of about 6000 Hz, preferably exactly 6000 Hz, for a predetermined period of time of at least 1-2 minutes and no more than about 5 minutes, preferably at least 5 minutes and no more than about 10 minutes, more preferably at least 10 minutes and no more than about 15 minutes, and even more preferably at least 15 minutes and preferably no more than about 20-30 minutes each hour every hour of one or more desired stages of growth of the plants 24 in the chamber 22. The acoustic or sound generation subsystem 66, preferably controller 72, can be configured to thereafter cease the delivery of all acoustical energy to the plants 24 in the chamber 22 for a predetermined period of time of between 2 minutes and 10 minutes before the sequence of delivering or outputting acoustical energy disclosed in the first sentence and/or second sentence of this paragraph is repeated. The acoustic or sound generation subsystem 66, preferably controller 72 can be further configured to alternate between cycles where the acoustical energy 70 is delivered to the plants 24 in the chamber 22 in accordance with that disclosed in this paragraph and then paused by ceasing output or delivery of the acoustical energy 72 the plants 24 in the chamber 22 in accordance with that also disclosed in this paragraph.

In yet another acoustic or sound generation subsystem embodiment and implementation of an acoustic stimulation method of the present invention, the acoustic stimulator 60, preferably acoustic or sound generation subsystem 66, via controller 72 is configured to vary the frequency of the sound outputted by the transducers 62, preferably speakers 64, into the growing atmosphere 26 in the chamber 22 between about 4000 Hz and 6000 Hz, where the initial frequency of sound outputted by the transducers 62, preferably speakers 64, starts at about 4000 Hz and the frequency increases over time, preferably over a first predetermined period of time, until the frequency of the sound outputted by the transducers 62, preferably speakers 64, reaches about 6000 Hz, ceasing sound output for a second predetermined period of time, and then repeating this cycle. In a preferred embodiment and method implementation, the 4000 Hz tone is outputted by the transducers 62, preferably loudspeakers 64, for at least one minute, preferably at least two minutes, before the frequency increases by at least about 250 Hz, preferably at least about 500 Hz, the increased frequency tone is outputted by the transducers 62, preferably loudspeakers 64, for at least one minute, preferably at least two minutes, before the frequency once again increases by at least about 250 Hz, preferably at least about 500 Hz, and is outputted for at least one minute, preferably at least two minutes, and this is repeated until the frequency of the tone outputted by the transducers 62, preferably loudspeakers 64, reaches 6000 Hz. Thereafter, all sound and/or tone(s) from the transducers 62, preferably loudspeakers 64, are ceased for at least one minute, preferably at least about two minutes, more preferably at least about five minutes, and even more preferably at least about ten minutes. This stepped frequency time duration pattern and method is repeated at least a plurality of times per hour. In one such embodiment and method implementation, this stepped frequency time duration pattern and method is repeated between three and four times per hour.

It is also contemplated as being within the scope of the present invention to provide yet another preferred embodiment and acoustical stimulation method implementation where the plants 24 can be and preferably are exposed to acoustical energy 70, preferably sound 70, from transducer(s) 62, preferably speaker(s) 64, having a frequency or frequencies of between 100 Hz and 1000 Hz, preferably between 250 Hz and 500 Hz, during one or more the aforementioned stages of plant growth, to facilitate plant growth, including simultaneously at the same time while the plants 24 are being subjected to tones from transducer(s) 62, preferably loudspeaker(s) 64, having a predetermined frequency, e.g., tone having a single frequency of 4000 Hz, 4250 Hz, 4500 Hz, 4750 Hz, 5000 Hz, 5250 Hz, 5500 Hz, 5750 Hz, or 6000 Hz, frequencies or frequency range(s) varying between 4000-6000 Hz, and/or variable or stepped frequencies, e.g., stepped from 4000 Hz, 4250 Hz, 4500 Hz, 4750 Hz, 5000 Hz, 5250 Hz, 5500 Hz, 5750 Hz, and 6000 Hz (or vice versa where the frequencies of the tone(s) are stepped from 6000 Hz to 4000 Hz decremented by 100 Hz, 250 Hz, 500 Hz, etc.). In one such embodiment and acoustical stimulation method implementation, acoustical energy 70, preferably in the form of sound 70, is outputted by transducer(s) 62, preferably loudspeaker(s) 64, having a frequency or frequencies of between 100 Hz and 1000 Hz, preferably between 250 Hz and 500 Hz, at certain predetermined times during one or more of the aforementioned stages of plant growth when the aforementioned 4000 Hz to 6000 Hz tones are not being outputted. In one embodiment and method implementation, the controller 74 can be configured to alternate an acoustical stimulation regime outputting tones in the 4000 Hz to 6000 Hz range for one predetermined period of time and then outputting sound 70 having a frequency or frequencies between 100 Hz and 1000 Hz, preferably between 250 Hz and 500 Hz for another predetermined period of time. In another embodiment, the controller 74 can be configured with an acoustical stimulation regime where one or more of the above-described 4000 Hz to 6000 Hz tone arrangements or configurations are outputted by the transducers 62, preferably loudspeakers 64, during one or more of the seedling stage, vegetative growth stage, flowering or budding stage, pollination and/or fertilization stage, fruiting/seed formation stage, ripening and/or maturation stage, and/or senescence and/or dormancy or death stage(s) of plant growth of the plants 24 in the chamber 22, and sound 70 having a frequency or frequencies between 100 Hz and 1000 Hz, preferably between 250 Hz and 500 Hz, is outputted by the transducers 62, preferably loudspeakers 64, during one or more of the other one(s) of the seedling stage, vegetative growth stage, flowering or budding stage, pollination and/or fertilization stage, fruiting/seed formation stage, ripening and/or maturation stage, and/or senescence and/or dormancy or death stage(s) of plant growth of the plants 24 in the chamber 22.

It is further contemplated within the scope of the present invention to expose the plants 24 in the chamber 22 to acoustical energy 70 from the acoustical stimulator 60, preferably acoustic or sound generation subsystem 66, in the form of music, preferably classical music, which can be played by the transducer(s) 62, preferably loudspeaker(s) 64, at the same time while the plants 24 subjected to tones from transducer(s) 62, preferably loudspeaker(s) 64, having a predetermined frequency, e.g., tone having a single frequency of 4000 Hz, 4250 Hz, 4500 Hz, 4750 Hz, 5000 Hz, 5250 Hz, 5500 Hz, 5750 Hz, or 6000 Hz, frequencies or frequency range(s) varying between 4000-6000 Hz, and/or variable or stepped frequencies, e.g., stepped from 4000 Hz, 4250 Hz, 4500 Hz, 4750 Hz, 5000 Hz, 5250 Hz, 5500 Hz, 5750 Hz, and 6000 Hz (or vice versa where the frequencies of the tone(s) are stepped from 6000 Hz to 4000 Hz decremented by 100 Hz, 250 Hz, 500 Hz, etc.). In another embodiment and acoustical stimulation method implementation, classical music is played by transducer(s) 62, preferably loudspeaker(s) 64, at certain predetermined times during one or more of the aforementioned stages of plant growth when the aforementioned 4000 Hz to 6000 Hz tones are not being played. In one embodiment and method implementation, the controller 74 can be configured to alternate an acoustical stimulation regime outputting tones in the 4000 Hz to 6000 Hz range and then outputting music, preferably classical music. In another embodiment, the controller 74 can be configured with an acoustical stimulation regime where one or more of the above-described 4000 Hz to 6000 Hz tone arrangements or configurations are outputted by the transducers 62, preferably loudspeakers 64, during one or more of the seedling stage, vegetative growth stage, flowering or budding stage, pollination and/or fertilization stage, fruiting/seed formation stage, ripening and/or maturation stage, and/or senescence and/or dormancy or death stage(s) of plant growth of the plants 24 in the chamber 22, and sound 70 in the form of music, such as preferably classical music, is outputted by the transducers 62, preferably loudspeakers 64, during one or more of the other one(s) of the seedling stage, vegetative growth stage, flowering or budding stage, pollination and/or fertilization stage, fruiting/seed formation stage, ripening and/or maturation stage, and/or senescence and/or dormancy or death stage(s) of plant growth of the plants 24 in the chamber 22.

The sound pressure level of the acoustical energy 70, preferably tone(s), outputted by the transducers 62, preferably loudspeakers 64, that the plants 24 are subjected to preferably is between about 50 decibels and about 110 decibels, preferably between 70 decibels and 100 decibels, and preferably does not exceed 115 decibels under any circumstances. In a preferred embodiment and method implementation, the sound pressure level of the acoustical energy 70, preferably tone(s), outputted by the transducers 62, preferably loudspeakers 64, encountered by the plants 24 is between 70 decibels and 110 decibels, preferably is between about 70 decibels and about 90 decibels.

One preferred embodiment of the plant lighting system 32 is depicted in FIG. 1 and is configured to deliver light 40 to one or more and preferably all of the plants 24 in the chamber 22 at light levels and irradiance ranges sufficient for photosynthesis in the plants 24 to occur and be sustained during one or more and preferably all of the seedling stage, the vegetative growth stage, the flowering or budding stage, the pollination and/or fertilization stage, the fruiting/seed formation stage, and the ripening and/or maturation stages of plant growth. Light 40 preferably is outputted from light emitters 84 that can be individual light emitting diodes (LEDs), but which preferably are the light emitting end 84 of each one of the fiber optic cables 86. Where fiber optic cables 86 are employed, the opposite ends of the fiber optic cables 86 are in communication with a fiber optic generator 88, which can be or include a fiber optic focusing unit, which provides a source of light that is transmitted through the fiber optic cables 86 and emitted from the light emitting ends 84 into the chamber 22 to irradiate the plants 24 in the chamber 22. The fiber optic generator 88 can include or also be a controller 90, e.g., configured with or as a controller 90, configured, including in software and/or firmware, to control one or more of (a) selective transmission of light through each individual fiber optic cable 86 to its respective emitting ends 84 and into the chamber 22, (b) the intensity of the light 40 delivered via the fiber optic cables 86 through their emitting ends 84 into the chamber 22, and/or (c) the wavelengths of the light 40 delivered via fiber optic cables 84 from emitting ends 84 into chamber 22.

In this regard, during at least the vegetative growth stage of plant growth of the plants 24 being grown in chamber 22, the fiber optic generator 88 and/or controller 90 can be configured, including at least partially in software and/or firmware, to selectively allow light 40 predominantly having wavelengths in the 400-500 nm blue light range to be emitted from the emitting ends 84 of the fiber optic cables 86 and irradiate the plants 24 in the chamber 22 with the predominantly blue light to facilitate growth of the vegetation of the plants 24 preferably stimulating the growth of at least the foliage 38 and stems of the plants 24. During the flowering and fruiting stage of plant growth of the plants 24 being grown in chamber 22, the fiber optic generator 88 and/or controller 90 can be configured to selectively allow light 40 predominantly having wavelengths in the 600-700 nm red light range to be emitted from the emitting ends 84 of the fiber optic cables 86 and irradiate the plants 24 with the predominantly red light to facilitate flowing and fruit production of the plants 24. Where it is desired to manipulate flowering times of the plants 24, the fiber optic generator 88 and/or controller 90 can be configured to selectively allow light 40 predominantly having wavelengths in the 700-750 nm far-red light range to be emitted from the emitting ends 84 of the fiber optic cables 86 and irradiate the plants 24 with the predominantly far-red light.

If desired, the plant lighting system 32 can include a selective wavelength filtering light filter 92, such as a light bandpass filter and/or a dichroic filter, disposed between the emitting ends 84 of the fiber optic cables 86 and the plants 24 in the chamber 22 that is configured to filter and/or substantially block transmission of (a) ultraviolet light having wavelengths of less than about 400 nanometers (nm), and/or (b) infrared light having wavelengths above about 750 nm. Where such a selective wavelength-filtering light filter 92 is employed that is configured to filter out ultraviolet light, it preferably is configured to filter and/or substantially block transmission of ultraviolet light having wavelengths of between about 100 nm and about 400 nm thereby advantageously preventing ultraviolet light cellular damage, DNA damage, protein damage, chlorophyll damage, damage to other cellular structures of the plants 24 as well as inhibition of photosynthesis and damage to other photosynthetic components of the plants 24. Where such a selective wavelength-filtering light filter 92 is employed that is configured to filter out infrared light, it preferably is configured to filter and/or substantially block transmission of light having wavelengths of above about 750 nm thereby advantageously preventing infrared light from reaching the plants 24 and causing dehydration, heat stress, and increased transpiration rates. If desired, the filter 92 can include or be used in conjunction with a diffuser 94 through which light from the emitting ends 84 of the fiber optic cables 86 passes before reaching or entering chamber 22 and irradiating the plants 24 in chamber 22.

The filter 92 can be a lens, panel, or layer disposed between the light emitting ends 84 of the fiber optic cables 86 and the growing atmosphere 26 in the growing chamber 22 disposing the filter 92 between the fiber optic cable emitting ends 84 and the plants 24 in the chamber 22. Where the filter 92 includes a diffuser 94, the filter 92 can also be configured to diffuse such that it is configured as a diffuser 94. Where diffuser 94 is separate from the filter 92, the diffuser 94 is disposed between the filter 92 and the growing atmosphere 26 within the chamber 22. The diffuser 94 can also be in the form of an outer light diffusing layer or lens of the filter 92 having one side or surface disposed in direct contact with the filter 92 and its opposite side or surface disposed in direct contact with the growing atmosphere 26 in the chamber 22.

In a preferred embodiment, the filter 92 is composed of a transparent light-transmissible acrylic and/or is made with at least one layer of the filter 92 composed of such a transparent light-transmissible acrylic as acrylic has desired selective light wavelength filtering characteristics as it filters (a) ultraviolet light having an ultraviolet light-filtering wavelength below about 400 nm and preferably filters ultraviolet let having wavelengths falling within the range of between about 100 nm and about 400 nm, and (b) preferably also filters infrared light having wavelengths above about 750 nm. Where the filter 92 is a diffuser 94 or there is a diffuser 94 separate from the filter 92, the diffuser 94 can also be composed of acrylic.

The fiber optic generator 88, controller 90, and/or filter 92 can be and preferably are configured to deliver light having an intensity and irradiance falling within a desired range or desired ranges suitable for sustaining photosynthesis of the plants 24 during growth of the plants 24 in the chamber 22. In a preferred embodiment and lighting system method implementation, the fiber optic generator 88, controller 90, and/or filter 92 are configured to irradiate light onto the plants 24 in the chamber 22 having a photon flux density, preferably photosynthetic photon flux density (PPFD) of between about 125 micromoles per square meter per second (μmol/m²/s) and about 900 μmol/m²/s with an irradiance of between about 75 watts per meter squared (W/m²) and about 700 W/m². In one such preferred embodiment and method implementation, the fiber optic generator 88, controller 90, and/or filter 92 are configured to irradiate light onto the plants 24 having a photon flux density, preferably PPFD, of between 200 and 800 μmol/m²/s and/or having an irradiance of between about 150 and 600 W/m².

With continued reference to FIG. 1, the fiber optic generator 88 of the plant lighting system 32 can be and preferably is linked to a processor equipped computing device 96, such as a computer, e.g., notebook computer or desktop computer, a tablet, a smart phone, or another type of computing device 96, which is configured in software and/firmware with a user-manipulable user interface 98 displayable on a screen 100 of the device 96 that enables a person who is a user or operator 80 of the growing system 20 to (a) control operation of the fiber optic generator 88 to selectively control transmission of light through one or more of the fiber optic cables 86 and/or emitting ends 84 thereof, such as to turn off light being transmitted to or through a select one or more of the fiber optic cables 86 such as to prevent light 40 from being emitted from the corresponding emitting ends 84 of those fiber optic cables 86 which were turned off, (b) control which wavelengths or wavelengths ranges of light 40 are being emitted from the emitting ends 84 of the fiber optic cables 86 into the growing chamber 22 that irradiate the plants 24 therein, and/or (c) control the light intensity and/or irradiance of the light 40 being emitted from the fiber-optic cable emitting ends 84 that irradiates the plants 24 growing in the growing chamber 22.

Where the fiber optic generator 88 is linked to such a processor equipped computing device 96, it can be directly linked via a physical link 102 like a data cable or the like, and/or linked via a network (not shown), such as where the fiber-optic generator 88 and computing device 96 are connected to the same network. In one preferred embodiment and method implementation, the processor equipped computing device 96 is connected by a wireless link, e.g. wirelessly linked, to the fiber-optic generator 88, such as by being wirelessly connected or wirelessly linked via a wireless network, such as the Internet.

With continued reference to FIG. 1, the fiber-optic generator 88 used to generate the light 40 that is emitted from the emitting ends 84 of the fiber-optic cables 86 into the chamber 22 is electrically powered by an electric power source 104 that preferably are or include at least a plurality of solar panels 106. Although not shown, the one or more solar panels 106 can output electrical power generated during daylight solar panel operation to a battery storage system (not shown) which in turn is electrically connected to the fiber-optic generator 88 and which can also be connected to the processor equipped computing device 96, such as in the case where it is directly linked to the fiber-optic generator 88.

Another preferred embodiment of a plant lighting subsystem 32′ is depicted in FIG. 2B and which is also configured to deliver light 40′ to one or more and preferably all of the plants 24 in chamber 22 at light levels sufficient for photosynthesis in the plants 24 to occur and be sustained. In the sunlight light-sourced plant lighting subsystem 32′, sunlight is gathered by sun-facing solar light-collecting panels 106′ disposed outdoors at a location exteriorly of the growing chamber 22 that communicates the gathered sunlight via fiber optic cabling 108 to a light distribution system 110 configured to distribute the sunlight through individual fiber optic cables 86 to the light emitting ends 84 of the cables 86 which emits sunlight into the growing chamber 24 to irradiate the foliage 38 of the plants 24 in the chamber 22. Although not shown, the solar light-collecting panels 106′ can also have one or more sunlight collecting or concentrating lenses, such as one or more Fresnel lenses, which can help maximize the amount of sunlight collected by each panel 106′.

The plant lighting subsystem 32′ can have and preferably does include a selective wavelength-filtering filter 92, such as preferably a light bandpass filter, like that used in the plant lighting subsystem 32 depicted in FIG. 1, which is disposed between each light emitting end 84 of each one of the fiber optic cables 86 and the plants 24 in the chamber 22 to filter sunlight emitted from the emitting ends 84 so that only filtered sunlight 40 reaches the plants 24. The filter 92 preferably is disposed between each emitting end 84 of each fiber optic cable 86 and at least part of the growing atmosphere 26 in the chamber 22 to filter sunlight emitted from the emitting ends 84 so that only filtered sunlight 40 enters the growing atmosphere 26 in the chamber 22 and irradiates the plants 24. If desired, the filter 92 can include or be composed of a diffuser 94 like that discussed above regarding the plant lighting subsystem 32 depicted in FIG. 1.

Filter 92 preferably is configured to at least partially and preferably substantially completely filter ultraviolet light having wavelengths of less than about 400 nanometers (nm), preferably filtering out 100-400 nm wavelengths, present in the sunlight emitted from the fiber optic cable emitting ends 84 to advantageously irradiate the growing chamber 22 and the plants 24 in the chamber 22 with filtered sunlight 40 substantially devoid of ultraviolet light. Filter 92 can also be configured to at least partially and preferably substantially completely filter infrared light having wavelengths above about 750 nm, present in the sunlight such that filtered sunlight 40 exiting the filter 92 into the chamber 22 is substantially devoid of infrared light. In a preferred embodiment of such a plant lighting subsystem 32′ equipped with such a selective wavelength-filtering filter 92, the filter 92 is configured to selectively filter both ultraviolet light and infrared light from the sunlight exiting the emitting ends 84 of the fiber optic cables 86 producing filtered sunlight 40 that exits the filter 92 that is composed substantially completely of visible light having wavelengths between about 400 nm and about 700 nm. As previously noted, such a filter 92 can include or be composed of an acrylic that can be transparent, but which selectively filters both ultraviolet and infrared light. Where the filter 92 includes, is composed of or is combined with a diffuser 94, the diffuser 94 can also be composed of an acrylic material.

In a preferred embodiment, the light distribution system 110 preferably includes a light distribution controller 112 configured to do one or more of the following: (a) control the light intensity of the filtered sunlight 40 irradiating the foliage 38 of the plants 24 in the chamber 22, (b) control the irradiance of the filtered sunlight 40 irradiating the plants 24, (c) selectively controlling the visible wavelengths and/or range(s) of visible wavelengths of light delivered to the light, and/or (d) the duration of light 90 delivered to the plants 24. In this regard, during the vegetative growth stage of plant growth of the plants 24 being grown in chamber 22, the controller 96 can be configured to selectively allow light 90 predominantly having wavelengths in the 400-500 nm blue light range to pass through, be delivered to, and irradiate the plants 24 in the chamber 22 with the predominantly blue light to facilitate growth of the vegetation of the plants 24 preferably stimulating the growth of at least the foliage 38 and stems of the plants 24. During the flowering and fruiting stage of plant growth of the plants 24 being grown in chamber 22, the controller 96 can be configured to selectively allow light 90 predominantly having wavelengths in the 600-700 nm red light range to pass through, be delivered to and irradiate the plants 24 with the predominantly red light to facilitate flowing and fruit production of the plants 24. Where it is desired to manipulate flowering times of the plants 24, the controller 96 can be configured to selectively allow light 90 predominantly having wavelengths in the 700-750 nm far-red light range to pass through, be delivered to, and irradiate the plants 24 with the predominantly far-red light.

The filter 92 can be a lens, panel, or layer disposed between the light emitting ends 84 of the fiber optic cables 86 and the growing atmosphere 26 in the growing chamber 22 disposing the filter 92 between the fiber optic cable emitting ends 84 and the plants 24 in the chamber 22. Where the filter 92 includes a diffuser 94, the filter 92 can also be configured to diffuse such that it is configured as a diffuser 94. Where diffuser 94 is separate from filter 92, the diffuser 94 is disposed between the filter 92 and the growing atmosphere 26 within chamber 22. The diffuser 94 can also be in the form of an outer light diffusing layer or lens of the filter 92 having one side or surface disposed in direct contact with the filter 92 and its opposite side or surface disposed in direct contact with the growing atmosphere 26 in the chamber 22.

In a preferred embodiment, the filter 92 is composed of a transparent light-transmissible acrylic and/or is made with at least one layer of the filter 92 composed of such a transparent light-transmissible acrylic as acrylic has desired selective light wavelength filtering characteristics as it filters (a) ultraviolet light having an ultraviolet light-filtering wavelength below about 400 nm and preferably filters ultraviolet let having wavelengths falling within the range of between about 100 nm and about 400 nm, and (b) preferably also filters infrared light having wavelengths above about 750 nm. Where the filter 92 is a diffuser 94 or there is a diffuser 94 separate from the filter 92, the diffuser 94 can also be composed of acrylic.

The light distribution system 110 can be configured with controller 112 that together with the filter 92 and/or diffuser 94 can be and preferably are configured to deliver filtered sunlight 40 having an intensity and irradiance falling within a desired range or desired ranges suitable for sustaining photosynthesis of the plants 24 during growth of the plants 24 in the chamber 22. In a preferred embodiment and lighting system method implementation, light distribution system 110, controller 112, filter 92 and/or diffuser 94 are configured to irradiate light onto the plants 24 in the chamber 22 having a photon flux density, preferably photosynthetic photon flux density (PPFD) of between about 125 micromoles per square meter per second (μmol/m²/s) and about 900 μmol/m²/s with an irradiance of between about 75 watts per meter squared (W/m²) and about 700 W/m². In one such preferred embodiment and method implementation, light distribution system 110, controller 112, filter 92 and/or diffuser 94 are configured to irradiate light onto the plants 24 having a photon flux density, preferably PPFD, of between 200 and 800 μmol/m²/s and/or having an irradiance of between about 150 and 600 W/m².

The light distribution system 110 and/or its controller 112 can be and preferably are linked to processor equipped computing device 96, such as computer, e.g., notebook computer or desktop computer, tablet, smart phone, or another type of computing device 96, which can be and preferably is configured in software and/firmware with user-manipulable user interface 98 displayable on screen 100 of the device 96 that is configured to enable a user or operator of such a plant growing system of the present invention to (a) control operation of the light distribution system 110 to selectively control transmission of light through one or more of the fiber optic cables 86 and/or light emitting ends 84 thereof, such as to turn off light being transmitted to or through a select one or more of the fiber optic cables 86, such as to prevent light from being emitted from the corresponding emitting ends 84 of those fiber optic cables 86 which were turned off, (b) control which wavelengths or wavelengths ranges of light are being emitted from the emitting ends 84 of the fiber optic cables 86 into the growing chamber 22 that irradiate the plants 24 therein, and/or (c) control the light intensity and/or irradiance of the light being emitted from the fiber-optic cable emitting ends 84 that irradiates the plants 24 growing in the growing chamber 22.

Where the light distribution system 110 and/or controller 112 are linked to such a processor equipped computing device 96, they can be directly linked via a physical link 102 like a data cable or the like, and/or linked via a network (not shown), such as where the fiber-optic generator 88 and computing device 96 are connected to the same network. In one preferred embodiment and method implementation, the processor equipped computing device 96 is connected by a wireless link, e.g. wirelessly linked, to the light distribution system 110 and/or controller 112, such as by being wirelessly connected or wirelessly linked via a wireless network, such as the Internet.

As previously noted above, the roots 36 of each plant 24 are at least partially received and preferably substantially completely received in a growing medium 28 in the chamber 22 that preferably is an aqueous hydroponic growing medium 28 and more preferably is a dispersion 29, such as a hydroponic liquid, a hydroponic colloid, a hydroponic emulsion, a hydroponic slurry, a hydroponic suspension, a hydroponic gel or another type of hydroponic dispersion where the hydroponic liquid, hydroponic colloid, hydroponic emulsion, hydroponic slurry, hydroponic suspension, hydroponic gel or other type of hydroponic dispersion is formulated with enough water, preferably at least 15% by weight, to produce a hydroponic dispersion that configures the hydroponic dispersion with enough water to ensure nutrient uptake through the roots 36, support plant photosynthesis, maintain plant turgor, facilitate temperature regulation and/or regulate temperature of the plants 24, and support the metabolism and metabolic processes of the plants 24. The growing medium 28 can be and preferably configured to receive compounds, which can include nutrients, hormones, enzymes, growth factor, and other compounds which preferably our bioactive compounds, which can be provided by a compound delivery subsystem (not shown) in communication with the growing medium 28 which can be and preferably is configured to deliver such compounds to the growing medium 28 in a form where they are nanosized or nanoscale, at least partially solubilized in the growing medium 28, dissolved in the growing medium 28, or otherwise carried by the growing medium 28 in a manner that enables their delivery to the roots 36 of each plant 24 in the growing chamber 22.

The growing medium oxygenating system 34 is fluidically coupled to growing medium 28 in the chamber 22 and configured to oxygenate the hydroponic growing medium 28 in a manner which enables the oxygenated hydroponic growing medium to supply oxygen to the roots 36 of the plants 24 in the chamber 22. In a preferred plant growing medium embodiment and implementation of a method of growing plants in accordance with the present invention, the growing medium oxygenating system 34 is constructed, arranged and configured to hyperoxygenate the hydroponic growing medium 28 with a great enough volume of nanosized oxygen nanobubbles diffused and/or dissolved into the hydroponic growing medium 28 to saturate and preferably supersaturate the hydroponic growing medium 28 with oxygen such that the hydroponic growing medium 28 contains at least 2 milligrams per liter (mg/L) of oxygen, preferably contains at least 3 mg/L of oxygen, and more preferably contains at least 5 mg/L of oxygen. In one preferred embodiment, the oxygenated growing medium 28 is a hyperoxygenated or oxygen supersaturated growing medium that contains between 5 mg/L and 10 mg/L and preferably between about 6.5 mg/L and about 8 mg/L oxygen. Advantageously, by the oxygen being diffused and/or dissolved into the water in the form of nanosized oxygen nanobubbles, the oxygen nanobubbles remain in solution in the hydroponic growing medium 28 for a much longer period of time than oxygen conventionally diffused, preferably remaining dissolved in the hydroponic growing medium 28 for at least one week, preferably at least 2 weeks, more preferably at least 3 weeks, even more preferably at least one month, and yet even more preferably at least 2 months. At least 25%, preferably at least 50%, more preferably at least 80%, and even more preferably at least 90% of the oxygen remains diffused and/or dissolved in the hydroponic growing medium 28 in the form of oxygen nanobubbles for at least one week, preferably at least 2 weeks, more preferably at least 3 weeks, even more preferably at least one month, and yet even more preferably at least 2 months. In one preferred embodiment and implementation of a method of oxygenating the growing medium in accordance with the present invention, the growing medium oxygenating system 34 is constructed, arranged and configured to hyperoxygenate and supersaturate the hydroponic growing medium 28 with between 5 mg/L and 10 mg/L oxygen, preferably between about 6.5 mg/L and about 8 mg/L oxygen, at least 25%, preferably at least 50%, more preferably at least 80%, and even more preferably at least 90% of which remain diffused in the hydroponic growing medium 28 in the form of oxygen nanobubbles for at least one week, preferably at least 2 weeks, more preferably at least 3 weeks, even more preferably at least one month, and yet even more preferably at least 2 months. By diffusing and/or dissolving oxygen into the hydroponic growing medium 28 in the form of nanosized oxygen nanobubbles, oxygen is advantageously more readily available for uptake by the roots 36 of the plants 24 in the chamber 22, remains more readily available for route uptake, and remains more readily available for root uptake for a longer period of time which in turn advantageously increases root growth, root system mass, and root hair growth which in turn advantageously increases plant growth rate, plant vegetation, and yield of plants 24 growing in the chamber 22.

With specific reference to FIGS. 1, 2A and 2B, the growing medium oxygenating system 34 has an oxygen generator 114 in communication with an atomizer 116 that is configured to discharge a stream of oxygen 118 and/or an oxygen-diffused and/or oxygen-dissolved water spray 120 into a pressurized oxygen diffusing and dissolution hyperoxygenated growing medium collection vessel 122. The pressurized collection vessel 122 collects oxygenated water 126 that preferably is hyperoxygenated or oxygen supersaturated water 126, preferably oxygenated growing medium 28 that preferably is a hyperoxygenated or oxygen supersaturated growing medium 28, containing oxygen bubbles that preferably are nanosized oxygen bubbles diffused and/or dissolved therein. During oxygenating system operation, the oxygenated water 126 exits as effluent 128 from a discharge at or adjacent the bottom of the pressurized hyperoxygenated growing medium collection vessel 122 and is delivered via a pump 130 through a conduit 132 to an inlet adjacent the bottom of the growing chamber 22 providing the chamber 22 with freshly hyperoxygenated hydroponic liquid growing medium 28 in which the roots 36 of each one of the plants 24 in the chamber 22 are at least partially immersed or submerged and which preferably are substantially completely immersed or submerged. Both the oxygenated water 126 in the oxygenated growing medium 28 are preferably both kept at a temperature of between 18° C. and 24° C. to prevent the diffused or dissolved oxygen, including oxygen bubbles, from being released or outgassed therefrom.

With specific reference to FIG. 2A, the oxygen generator 114 is or includes an electrolyzer 134, which can be of conventional construction, whose construction is simplified in FIG. 2A for clarity to only show an enclosure 136 holding a liquid 138, preferably water 140, an anode 142, which generates oxygen 118, preferably in the form of substantially pure oxygen gas 118, during electrolysis, and a cathode 144, which generates hydrogen 146, preferably in the form of substantially pure hydrogen gas 148, during electrolysis. Enclosure 136 has an inlet 135 through which liquid 138, preferably water 140, is added and has a pressure relief port 137 configured to relieve pressure within the electrolyzer 134 should the pressure inside the enclosure 136 become too great. The anode 142 and cathode 144 spaced apart, extend parallel to each other, and are connected by electrical power lines 150 to a power supply 152 configured to supply voltage and current sufficient to initiate and sustain electrolysis by the electrolyzer 134 and generate the oxygen 118 needed to hyperoxygenate the hydroponic growing medium 28. The hydrogen gas 146 generated by the electrolyzer 134 is collected from the cathode 144 via a conduit 154 that delivers the hydrogen gas 146 to a compressor 156 that pressurizes and compresses, condenses or liquefies the hydrogen gas 146 before delivering it to a hydrogen storage tank 158.

During electrolysis during operation of the electrolyzer 134, nanosized bubbles 125 (exaggerated for clarity in FIG. 2A), i.e., nanobubbles 125, of oxygen 118 are formed on the surface of the anode 142 in contact with liquid 138, preferably water 140, in the electrolyzer enclosure 136 that diffuse and/or dissolve into the liquid 138, preferably water 140, inside the electrolyzer 134, that preferably becomes hyperoxygenated and which is used to at least partially make up the oxygenated water 126 that ends up falling due to gravity to the bottom of the pressurized collection vessel 122. In a preferred embodiment where water 140 is the liquid 138 inside the electrolyzer 134, the water 140 becomes hyperoxygenated makeup water 145 as a result all of the oxygen nanobubbles 125 being dissolved or diffusing into the water 148 in the electrolyzer 134. In such a preferred embodiment, the hyperoxygenated makeup water 145 produced during electrolyzer operation, contains at least 0.25 mg/L of oxygen, preferably at least 1 mg/L of oxygen, and more preferably contains at least 2 mg/L of oxygen but no more than about 5 mg/L of oxygen in the form of nanosized oxygen nanobubbles 125.

The electrolyzer 134 preferably uses electrophoresis to generate the nanosized oxygen nanobubbles 125 by applying an electric field to an aqueous solution, preferably water 140, where oxygen gas is either dissolved or continuously supplied. When an electric field is applied to a liquid 138, preferably an aqueous liquid, more preferably water 140, which contains dissolved oxygen, the oxygen molecules migrate towards the electrode, often the anode 142, with an opposite charge due to electrical forces exerted on ions or molecules in the solution 138, preferably aqueous liquid, more preferably water 140 in the electrolyzer. At electrode 142, if the electric field is strong enough, water molecules can undergo electrolysis. This breaks down water into oxygen and hydrogen gas at the respective electrodes 142, 144. Oxygen gas accumulates at the anode 142, forming microbubbles or nanobubbles due to the local supersaturation of oxygen in liquid 138, preferably aqueous liquid, more preferably water 140 near the surface of the electrode 142. Oxygen nanobubbles 125 form as the oxygen gas produced by electrolysis nucleates and grows into tiny bubbles. The high surface charge on these nanobubbles 125, created by the electric field, helps to stabilize them, preventing them from coalescing into larger bubbles and allowing them to remain suspended in solution in the hyperoxygenated makeup water 145 as advantageously stable nanobubbles 125. The nanobubbles 125 or advantageously stable because they are retained as discrete nanosized nanobubbles 125 in the hyperoxygenated hydroponic growing medium 28 in which the roots 36 of the plants 24 in the chamber 22 are immersed. These nanobubbles 125 are advantageously stably maintained within the hyperoxygenated hydroponic growing medium 28 for at least one week, preferably at least 2 weeks, more preferably at least 3 weeks, even more preferably at least one month and yet even more preferably at least 2 months. As a result, oxygen nanobubbles 125 remain readily available in the hyperoxygenated hydroponic growing medium 28 in which the roots 36 of the plants 24 in the chamber 24 for more efficient and expeditious uptake by the roots 36 even enabling the roots 36, preferably substantially the entire root system 37, to be substantially completely immersed or submerged for at least one week, preferably at least 2 weeks, more preferably at least 3 weeks, even more preferably at least one month and yet even more preferably at least 2 months without the roots 36 rotting, experiencing oxygen deprivation, experiencing a nutrient deficiency, and/or wilting while advantageously even increasing the rate of plant growth, plant yield, increased germination rate, and the like.

With continued reference to FIG. 2A, the electrolyzer enclosure 136 has an outlet 160 in communication with a pump 162 that withdraws hyperoxygenated liquid 138, preferably hyperoxygenated makeup water 145, and pumps it through a conduit 164 to an intake 166 of atomizer 116 that discharges it under pressure from a nozzle 166 of the atomizer 116 into a pressurized hyperoxygenated vapor containing atmosphere 168 inside the pressurized hyperoxygenated liquid, preferably hyperoxygenated water, collection tank 112. With the exception of oxygen containing or oxygen-carrying water vapor in the atmosphere 168 from the atomizer nozzle 166, the atmosphere 168 within the collection tank 112 preferably is substantially completely composed of oxygen under a sufficiently high enough pressure to cause oxygen in the atmosphere to readily go into solution in the oxygenated water 126 at the bottom of the tank 112. To help maintain such a desirably high solubility, the temperature within the tank 112, particularly the temperature of the hyperoxygenated water 126 at the bottom of the tank 112, also is kept at a desirably high temperature of at least 15° C. and which preferably is no greater than 30° C., more preferably is between about 18° C. and about 24° C. Because the atmosphere 168 within the collection tank 112 is pressurized, maintaining the temperature of the oxygenated water 126 in the collection tank 112 also advantageously helps oxygen in the pressurized atmosphere 168 to diffuse and/or become dissolved in the oxygenated water 126 in the tank. The electrolyzer 134 also has a conduit 182 through which gaseous oxygen 118 from the anode 142 is drawn into a compressor 184 where the oxygen 118 is pressurized before it is transported via conduit 186 to a high-pressure oxygen reservoir 188 in gas flow communication with a gas regulator 190 preferably selectively controllable gas flow regulator unit 190, configured to controllably deliver a desired rate of flow of pressurized oxygen from the reservoir 188 via conduit 192 to a gas inlet 194 of the atomizer 116.

During atomizer operation, the hyperoxygenated makeup water 145 received by the intake 166 of the atomizer 116, travels through an elongate atomizer tube 170 (shown in phantom in FIG. 2A) within an outer tubular housing 172 of the atomizer 166 that defines a generally annular pressurized oxygen transport conduit 174 that receives oxygen from inlet 194 which operably cooperate with each to form an atomizer mixing chamber 176 therebetween that mixes the hyperoxygenated makeup water 145 and pressurized oxygen 118 and propels it out the atomizer nozzle 178 as atomized hyperoxygenated nanosized oxygen nanobubble containing or carrying water vapor 180 into the pressurized hyperoxygenated water vapor containing atmosphere 168 within pressurized collection tank 112. Pressurization of the oxygen helps increase solubility within the pressurized hyperoxygenated liquid collection tank 112 to help facilitate soluble sensation of oxygen, including nanosized oxygen nanobubbles, into the pool of oxygenated, preferably hyperoxygenated and/or oxygen supersaturated, water 126 at the bottom of the tank 112. In addition, the gaseous atmosphere 168 within the tank 112 preferably is maintained at a gas pressure of at least 200 PSI and preferably at least 225 PSI, more preferably at least 250 PSI, and even more preferably at least 275 PSI to suitably increase solubility to a level that facilitates solubilization of oxygen, including nanosized oxygen nanobubbles, into the oxygenated water 126 at the bottom of the tank 112. To help maintain such a desirably high solubility, the temperature within the tank 112, particularly the temperature of the oxygenated water 126 at the bottom of the tank 112, also is kept at a desirably high temperature of at least 15° C. and which preferably is no greater than 30° C., more preferably is between about 18° C. and about 24° C. To help maintain the pressure of the oxygen and vaporous atmosphere 168 within the pressurized collection tank 112 at or above 200 PSI, preferably at or above 225 PSI, more preferably at or above 250 PSI and even more preferably at or above 275 PSI, a compressor 194 is connected to the tank 112 in gas flow communication with the atmosphere 168 of the tank 112, preferably via a recirculation loop 196 as depicted in FIG. 2B. In a preferred embodiment and hyperoxygenated method implementation, the oxygenating system 34 can include another source 200 of oxygen 202, such as in the form of a tank 204 of compressed or liquefied oxygen, that can be delivered, including selectively or controllably delivered, such as by using a gas regulator, gas regulating system or gas regulating controller (not shown), to the collection tank 112 during hyperoxygenated water creation during oxygenating system operation. To prevent too great of a pressure from building up within the tank 112, the tank preferably has a pressure regulating valve 198 that can be and preferably is one or both of a pressure valve and/or pressure relief valve that can be configured to vent to the ambient atmosphere when the pressure inside the tank 112 exceeds a predetermined maximum pressure.

The hyperoxygenated nanosized oxygen nanobubbles containing or carrying vapor 180 is composed of at least a plurality of pairs, i.e. at least three, of tiny droplets of water that each carry or hold at least a plurality of pairs of nanosized oxygen nanobubbles dissolved or diffused therein. In a preferred embodiment and method implementation, hyperoxygenated nanosized oxygen nanobubbles containing or carrying vapor 180 is composed of at least a plurality of pairs of nanosized water droplets that each carry or hold at least a plurality of pairs of even smaller nanosized oxygen nanobubbles dissolved or diffused in each of the droplets.

Not only does the hyperoxygenated nanosized oxygen nanobubbles containing or carrying vapor 180 condense into the oxygenated water 126, preferably hyperoxygenated and/or supersaturated oxygenated water 126, in the bottom of the tank 112 diffusing and/or dissolving its nanosized oxygen nanobubbles in the oxygenated water 126 increasing its hyperoxygenation but the atmosphere within the tank is sufficiently highly pressurized to cause oxygen in the atmosphere also to diffuse or dissolve into the oxygenated water 126.

In a preferred embodiment, the atomizer 116 preferably is a nebulizer 115, preferably a charged nebulizer, that charges each one of the droplets in the vapor 180 discharged from the nozzle 178 causing the nanosized oxygen nanobubbles dissolved or diffused they are and to more readily be incorporated into the oxygenated water 126 disposed in the bottom of the collection tank. As is needed, hyperoxygenated liquid 138, preferably hyperoxygenated water 140 is withdrawn from the collection tank 112 as hyperoxygenated effluent 128 by pump 130 which delivers it via conduit 132 to the bottom portion of the growing chamber 22 to be used as hyperoxygenated hydroponic growing medium 28 in accordance with the present invention.

In a preferred embodiment and method implementation, the gas regulator 190 preferably is, includes or is configured as a controller 206 which in turn is configured with an interface to be connected by a link, which can be a cable link, network link, and/or wireless link, e.g. the Internet, to a processor equipped computing device 210 configured with a user interface 212 that is visually displayable on a screen 214 of the device 210 which is manipulable by a user that is an operator of the system 20. The controller 206 and/or processor equipped computing device 210 can be configured, such as in software and/or firmware, to regulate the flow and/or amount of oxygen delivered to the pressurized collection vessel 112, including the flow and/or amount of oxygen delivered to the atomizer 116, preferably nebulizer 115. The controller 206 and/or processor equipped computing device 210 can be configured, such as in software and/or firmware, to interface with one or more oxygen sensors (not shown) in communication with the hyperoxygenated hydroponic growing medium 28 in the chamber 22 to regulate flow of newly hyperoxygenated liquid, preferably hyperoxygenated water 128 drawn from the pressurized collection vessel 112 and delivered to the hydroponic growing medium 28 in the chamber 22 when the amount or level of oxygen in the growing medium 28 in the chamber 22 drops below a predetermined oxygen level, oxygen amount or oxygen percentage threshold.

The controller 206 and/or processor equipped computing device 210 can also be configured, such as in software and/or firmware, to control operation of a pump 216 depicted in FIG. 1 in fluid flow communication with a recirculation loop 218 that is configured to circulate flow of the hydroponic growing medium 28 the chamber 22 so as to cause movement or cross flow of the hydroponic growing medium 20 within the chamber 22 relative to the roots 36 of the plants 24 growing in the chamber 22. Such a crossflow recirculating loop configuration advantageously causes the hyperoxygenated hydroponic growing medium 28 to flow across the roots 36 of the plants 24 thereby stimulating nutrient and oxygen uptake through the roots 36 during one or more phases of growth of the plants 24 in the chamber 22. Although not shown, a chiller can be provided in fluid flow communication with the hyperoxygenated hydroponic liquid growing medium 28 to regulate temperature of the growing medium 28 as well as the temperature of the plants 24 in the chamber 22 and/or the temperature of the growing atmosphere 26 in the chamber 22. Where equipped with such a chiller, the chiller can be disposed in line in the recirculation loop 218 such that all of the hyperoxygenated hydroponic growing medium 28 that passes through the loop 218 also passes through the chiller chilling or cooling the hydroponic growing medium 28.

With continued reference to FIG. 1, the system 20 can also include a root or growing medium compound delivery subsystem 55 configured for delivery of one or more bioactive compounds, such as nutrients, enzymes, peptides, hormones, or another type of useful or effective bioactive compound to the hydroponic growing medium 28 in the growing chamber 22 for uptake by the roots 36 or root systems 45 of the plants 24 growing in the chamber 22 during one or more phases of growth of the plants 24. The bioactive compounds of the root or growing medium compound delivery subsystem 55 preferably are water soluble and become solubilized and substantially uniformly distributed throughout the growing medium 28 in the chamber 24 enabling uptake thereof by the roots 36 of the plants 24 immersed in the growing medium 28. The root or growing medium compound delivery subsystem 55 has a first pump 220 in fluid flow communication with a first bioactive compound source 222, such as preferably containing one or more water-soluble nutrients, which in turn is in fluid flow communication with the hydroponic growing medium 28, preferably via recirculation loop 218, in the growing chamber 22 for uptake by the roots 36 of the plants 24 in the chamber 22. The root compound delivery subsystem 55 preferably also includes a second pump 224 in fluid flow communication with a second bioactive compound source 226, such as containing one or more hormones, preferably one or more plant growth hormones, more preferably one or more water-soluble plant hormones, which in turn is in fluid flow communication with the hydroponic growing medium 28, preferably via recirculation loop 218, in the growing chamber 22 also for uptake by the roots 36 of the plants 24 in the chamber 22. If desired, operation of one or both pumps 220, 224 can be controlled by a controller (not shown) linked to a processor equipped computing device configured in firmware and/or software including with the user interface that is manipulable by the operator 80 of the system.

With reference once again to FIG. 2B, the system 20 preferably also includes a shoot system or foliage compound delivery subsystem 30, that preferably is a plant stomata compound delivery system 30, having a plurality of spaced apart atomizers 230 carried by a plurality of spaced apart arms 232 of a gantry 234 movable along a track system 236 within the chamber 22 and relative to at least one of the plants 24 in the chamber 22 where each atomizer 230 is configured to atomize one or more compounds, preferably bioactive compounds, in a compound-containing cloud or mist 245 of compound-carrying droplets which preferably are nanosized that are discharged by the atomizers 230 into the growing atmosphere 26 aimed towards at least one of the plants 24 so they can be delivered directly onto the shoots 45, e.g., stem(s), and foliage 38 of the plants 24, preferably including leaves 47 of the plants 24, for uptake by the stomata of the shoots 45, leaves 47 and other foliage 38 of the plants 24 during one or more of the aforementioned stages of plant growth. The compound delivery system 30 is configured to apply one or more bioactive compounds onto at least one plant 24 in the chamber 22, including one or more water-soluble nutrients, one or more hormones, e.g. growth hormone, one or more enzymes, one or more peptides, and/or one or more other types or kinds of bioactive compounds via atomization in a mist 245 of compound carrying droplets. Where the bioactive compound is or includes at least one growth hormone, growth hormones such as Auxins, Gibberellins, Cytokinins, Ethylene, abscisic Acid and/or Brassinosteroids can be applied in a liquid carrier, preferably water carrier, in the form of nanosized atomized bioactive compound carrying droplets sprayed from the atomizers 230 during a plant hormone bioactive compound application cycle. Where the bioactive compound is or includes at least one nutrient, nitrogen (N), phosphorus (P), potassium (K), calcium (Ca), magnesium (Mg), and/or sulfur(S) can be applied in a liquid carrier, preferably water carrier, in the form of nanosized atomized bioactive compound carrying droplets sprayed from the atomizers 230 during a stomatal nutrient feeding cycle. If desired, a bioactive compound application cycle can involve applying a plurality, even a plurality of pairs of, i.e. at least three, of a nutrient and a hormone, a peptide and a hormone, a peptide and a nutrient, or a nutrient, hormone, and a peptide combined and atomized together into a mist or cloud of nanosized multiple different type bioactive compound carrying droplets discharged from the atomizers 230 during an application cycle.

Each compound preferably is a water-soluble compound that is mixed with or dissolved in water that is then atomized into a mist 245 composed of at least a plurality, preferably at least a plurality of pairs of nanosized bioactive compound carrying droplets carried by the atmosphere 26 in the chamber 22 onto the plant 24 and/or the nanosized bioactive compound carrying droplets sprayed by the spaced apart atomizers 230 substantially uniformly directly onto the plant 24. The arms 232 of the gantry 234 extend outwardly from an elongate support 238, which can be a post or tube of telescopic construction, and which is mounted to a vertically extending track 240 configured for enabling up-and-down movement of the atomizers 230 relative to one of the plants 24 in the chamber 22. The gantry 234 also is carried by a generally horizontally extending overhead track 242 overlying the plants 24 that is configured to enable movement of the entire gantry 234, including the arms 232 and the atomizers 230, relative to the plants 24 in the chamber 22 from plant 24 to another plant 24. As is also depicted in FIG. 3, the arms 232 are spaced apart by a great enough distance so as to position a generally vertically spaced apart and aligned plurality of pairs of atomizers 230 mounted to each arm 232 alongside the foliage of a plant 24 undergoing a bioactive compound application cycle such that the atomized mist carrying the at least one bioactive compound substantially uniformly applies the bioactive compound on the foliage 38 and preferably also the stem(s) 45 of the plant 24. The arms 232 can also rotate 360° about the vertical axis thereby enabling the plurality of pairs of uniformly or equidistantly spaced apart atomizers 230 mounted to each arm 232 to substantially uniformly atomize and apply the at least one bioactive compound to the foliage 38 and shoot(s) 45 of the plant 24 being treated with the at least one bioactive compound substantially uniformly about the entire periphery of the foliage 38 and shoot(s) 45 of the plant 24.

The gantry 234 is configured for rotary movement 360 degrees about a generally vertical lengthwise extending axis of rotation with the arms 232 spaced apart and extending generally vertically downwardly parallel to one another for enabling each one of the arms 232 and the plurality of pairs of, i.e. at least three, atomizers 230 carried by the arm 230 to be rotated around an outer periphery of the foliage 38 of one plant 24 at a time such as when carrying out a bioactive compound application cycle, e.g., nutrient feeding cycle. Enabling the arms 232 to rotate about a generally vertically extending longitudinal axis of rotation enables the atomizers 230 carried by the arms 232 to spray droplets containing one or more bioactive compounds carried or dissolved therein onto the foliage 38 and shoots 45 of the plant 24 being subject to a bioactive compound application cycle about which the arms 232 are rotating. This advantageously ensures more uniform coverage and application of the bioactive compounds via the atomized mist onto the stomata of the foliage 38 and/or shoots 45 of the plant 24 helping to ensure more uniform and rapid uptake by and into the stomata of the foliage 38 and/or shoots 45 of the plant 24 during and after application. In a preferred embodiment and method implementation, each one of the atomizers 230 used for bioactive compound application preferably is a nebulizer 235 (FIG. 3) configured to charge the nanosized bioactive compound carrying droplets discharged from the nozzle 237 of the nebulizer 235.

With reference once again to FIG. 2B, the bioactive compound application or treatment subsystem 30 has a source 248 of at least one bioactive compound 250 in a tank, vessel or other container 252 and a source 254 of at least one atomizing gas 256, such as preferably nitrogen because the plant 24 can use the nitrogen as a nutrient, which is delivered to a mass flow controller 258 which controls their respect mass flow rates of delivery (and rate of atomized application on a plant 24) through separate lines 260, 262 to the atomizer 230, preferably nebulizer 235, where the gas 256 and at least one bioactive compound 250 are combined to atomize the at least one bioactive compound 250 into nanosized atomized droplets applied onto the shoots, leaves and foliage of at least one plant 24 in the chamber 22 for stomatal uptake by the plant 24. In a preferred embodiment and implementation of a method of applying at least one bioactive compound for stomatal uptake, the bioactive compound application or treatment system 30 also includes a source 264 of at least one surfactant 266 that can be mixed with the at least one bioactive compound 250 at the mass flow controller 258 or delivered via a separate line 268 to the atomizer 230, preferably nebulizer 235, where the atomization or nebulization process combines the at least bioactive compound 250 and the at least one surfactant 266 with the atomizing gas 256 to discharge atomized or nebulized nanosized droplets therefrom into the growing atmosphere 26 in the chamber 22 and/or onto the shoots 45 and foliage 38 of at least one plant 24 in the chamber 22 being treated with the at least one bioactive compound 250 for stomatal uptake thereby. As is also shown in FIG. 2B, the at least one bioactive compound 250 and the at least one surfactant 266 are preferably delivered to the mass flow controller 258 by a corresponding pump 267, 269. In a preferred embodiment where a nebulizer 235 is employed, the nebulizer preferably is a charged nebulizer 235 or an electrostatic nebulizer 235 that charges droplets discharged into the growing atmosphere therefrom with an electrostatic charge that can be one of a positive and negative charge that causes the droplets, preferably nanosized droplets, to be attracted to the foliage including the shoots, shoot system and/or leaves of the plant thereby more efficiently delivering the droplets to the plant such as preferably for feeding the plant. In one preferred embodiment, the bioactive compound delivery system is a feeding system that delivers liquid fertilizer containing one or more nutrients as well as preferably at least one surfactant in the form of an aerosol cloud composed of droplets, preferably nanosized droplets, discharged from an atomizer 230 that preferably is a charged atomizer 230, e.g. electrostatic atomizer 230, or a nebulizer 235 that preferably is a charged nebulizer 235, e.g., electrostatic nebulizer 235, whose electrostatic charge causes the droplets to be attracted to the foliage so they are more readily taken up by stomata of the foliage and which contain surfactant that decreases the surface tension of the droplets thereby more uniformly spreading the fertilizer therein along the stomata containing surface of the foliage when wetted thereby which also causes the fertilizer to be drawn into stomata by a wicking action due to the presence of the surfactant.

As previously noted, the at least one bioactive compound can be a nutrient, such as one or more of the nutrients disclosed hereinabove, a hormone, such as one or more of the hormones disclosed above, a peptide, another type of bioactive compound, and/or combinations thereof. The at least one surfactant preferably is a food grade or food safe surfactant like polysorbate 20, sodium dodecyl sulfate, monoglycerides, diglycerides, sorbitan monostearate, sucrose esters, glycerol monostearate (GMS), propylene glycol esters of fatty acids (PGFA), sodium stearoyl lactylate (SSL), or another type of food grade or food safe surfactant. Use of such a surfactant together with the bioactive compound is critical to ensure system model uptake of the bioactive compound into the stomata of the plant 24 being treated with the at least one bioactive compound including by causing the at least one bioactive compound to wick into the stomata of the plant 24 being treated.

If desired, the bioactive compound application or treatment subsystem 30 can be configured to control operation of the mass flow controller 258 by being linked, such as wirelessly and/or via a network, with a processor equipped computing device 270 equipped with a user interface 272 visually displayable on a screen 274 of the device 270 which is manipulable by an operator 80 of the system 20.

The present invention also is directed to a method for growing plants (a) providing (1) a growing chamber having (i) a growing atmosphere holding compartment holding a growing atmosphere and (ii) an aqueous liquid growing medium holding tank holding an aqueous liquid growing medium, (2) a source of plant lighting, (3) an arrangement configured for stomatal plant feeding of at least one nutrient delivered to stomata of a shoot system and/or foliage of a plant being grown in the growing chamber via the growing atmosphere in the growing atmosphere holding compartment, (4) an arrangement configured for oxygenating the aqueous liquid growing medium in the aqueous liquid growing medium holding tank, and (5) at least one plant of a type or variety received in the growing chamber, the plant having a shoot system received in the growing atmosphere in the growing atmosphere holding compartment and a root system at least partially immersed in the aqueous liquid growing medium in the aqueous liquid growing medium holding tank where the method includes one or more of the steps of (b) increasing an amount of carbon dioxide in the growing atmosphere in the growing atmosphere holding compartment to a percentage or parts per billion amount greater than the percentage or parts per billion of carbon dioxide in the earth's atmosphere, (c) increasing a pressure of the growing atmosphere in the growing atmosphere holding compartment to a pressure greater than the pressure of the earth's atmosphere, (d) oxygenating the aqueous liquid growing medium in the aqueous liquid growing medium holding tank, (c) oxygenating the aqueous liquid growing medium in the aqueous liquid growing medium holding tank, and/or (f) providing a source of light in the growing chamber that irradiates the at least one plant in the growing chamber with enough light for photosynthesis to occur. The pressure of the growing atmosphere in the growing atmosphere compartment of the growing chamber is at least a plurality of times, preferably at least a plurality of pairs of, i.e., at least three, times the earth's atmospheric pressure. As discussed in more detail below, the growing atmosphere is an enhanced CO2 growing atmosphere containing a greater percentage or parts per billion of CO2 than the percentage or parts per billion of CO2 in the earth's atmosphere.

The present invention further contemplates an auditory stimulation step using an arrangement for auditorily stimulating plant growth through the use of one or more transducers, e.g. loudspeakers, in operable cooperation with the growing atmosphere holding compartment which emit vibration, e.g. sound, at frequencies optimal for stimulating plant growth, preferably shoot growth of plants being grown in the growing chamber of the present invention. If desired, the transducers can be disposed within the growing chamber and/or in contact with part of the structure of the growing chamber, such as portion of a wall or panel which makes up part of the growing atmosphere holding compartment of the growing chamber.

The at least one plant grown in the growing chamber grows to maturity to a size at least a plurality of times, preferably a plurality of pairs of times, greater than a size of a plant of the same type or variety grown in the earth's atmosphere with its root system rooted in soil. In one preferred method implementation, the at least one plant is a common bean (Phaseolus vulgaris) and the common bean grows using the growing chamber of the present invention to maturity to a size that is at least five times, preferably at least seven times, greater than the size of a common bean grown in the earth's atmosphere with its root system rooted in soil.

In a preferred method implementation, the growing atmosphere in the growing atmosphere holding compartment contains at least 500 parts per billion carbon dioxide, preferably contains at least 600 parts per billion carbon dioxide, more preferably contains at least 750 parts per billion carbon dioxide, even more preferably contains at least 800 parts per billion carbon dioxide, still even more preferably contains at least 900 parts per billion carbon dioxide, and yet still even more preferably contains at least 1000 parts per billion carbon dioxide. In a preferred embodiment, the growing atmosphere in the growing atmosphere holding compartment is composed substantially completely of carbon dioxide. As previously noted, during this time the enhanced or increased carbon dioxide growing atmosphere in the growing atmosphere holding compartment is pressurized to a chamber pressure that is at least a plurality of times the earth's atmospheric pressure and preferably is pressurized to a pressure that is a plurality of pairs of times the earth's atmospheric pressure.

In another preferred method implementation, the growing atmosphere in the growing atmosphere holding compartment contains at least 5% by volume of carbon dioxide, preferably contains at least at least 10% by volume carbon dioxide, more preferably contains at least at least 15% by volume carbon dioxide, even more preferably contains at least at least 20% by volume carbon dioxide, still even more preferably contains at least at least 25% by volume carbon dioxide, yet still even more preferably contains at least at least 35% by volume carbon dioxide, still even more preferably contains at least at least 50% by volume carbon dioxide, still even more preferably contains at least at least 60% by volume carbon dioxide, still even more preferably contains at least at least 75% by volume carbon dioxide, still even more preferably contains at least at least 80% by volume carbon dioxide, and still even more preferably contains at least at least 90% by volume carbon dioxide. In a preferred embodiment, the growing atmosphere in the growing atmosphere holding compartment is composed substantially completely of carbon dioxide. As previously noted, during this time the enhanced or increased carbon dioxide growing atmosphere in the growing atmosphere holding compartment is pressurized to a chamber pressure that is at least a plurality of times the earth's atmospheric pressure and preferably is pressurized to a pressure that is a plurality of pairs of times the earth's atmospheric pressure.

In a preferred method implementation, the arrangement configured for stomatal plant feeding of nutrients is configured to deliver the at least one nutrient by the growing atmosphere in the growing atmosphere holding compartment carrying the at least one nutrient in the growing atmosphere to stomata of the shoot system and/or foliage of the at least one plant growing in the growing chamber. In one such preferred method implementation, the arrangement configured for stomatal plant feeding of nutrients is configured to nebulize at least one nutrient and transport the nebulized at least one nutrient via the growing atmosphere in the growing atmosphere holding compartment to stomata of the shoot system of the at least one plant growing in the growing chamber for taking up the nebulized at least one nutrient into the stomata of the at least one plant during plant respiration during growing chamber operation.

In another preferred implementation, the arrangement configured for stomatal plant feeding of nutrients is or includes a nebulizer configured to discharge at least one or more of nanosized nebulized liquid-containing droplets or particles and nanosized nebulized liquid-carrying droplets or particles each composed of at least one nutrient to facilitate stomatal entry into and/or passage through stomata of the shoot system of the at least one plant in the growing chamber during growing chamber operation. In one such embodiment, the nebulizer is a charged nebulizer made in whole or in part out of glass. In one such preferred implementation, the arrangement configured for stomatal plant feeding of nutrients is or includes a charged nebulizer which electrostatically charges one or more of the nebulized liquid-containing droplets or particles and/or nebulized liquid-carrying droplets or particles composed of the at least one nutrient facilitate attraction of the one or more of nebulized liquid-containing droplets or particles and nebulized liquid-carrying droplets or particles composed of the at least one nutrient to the shoot system of the at least one plant in the growing chamber to facilitate stomatal feeding of the at least one plant.

The arrangement configured for stomatal plant feeding of nutrients that employs a nebulizer utilizes the at least one nutrient as being composed of at least one of (a) liquid solubilized nitrogen, (b) liquid solubilized phosphorous, (c) liquid solubilized potassium, (d) liquid solubilized magnesium, (e) liquid solubilized calcium, (f) liquid solubilized sulfur and/or (g) one or more liquid solubilized micronutrients including one or more of (i) manganese, (ii) copper, (iii) zinc, (iv) boron, (v) molybdenum, and (vi) chlorine. The at least one of (a) liquid solubilized nitrogen, (b) liquid solubilized phosphorous, (c) liquid solubilized potassium, (d) liquid solubilized magnesium, (e) liquid solubilized calcium, (f) liquid solubilized sulfur and/or (g) one or more liquid solubilized micronutrients including one or more of (i) manganese, (ii) copper, (iii) zinc, (iv) boron, (v) molybdenum, and (vi) chlorine preferably is composed of at least one of (a) water solubilized nitrogen, (b) water solubilized phosphorous, (c) water solubilized potassium, (d) water solubilized magnesium, (c) water solubilized calcium, (f) water solubilized sulfur and/or (g) one or more water solubilized micronutrients including one or more of (i) manganese, (ii) copper, (iii) zinc, (iv) boron, (v) molybdenum, and (vi) chlorine.

During the light providing step (f), the light provided to the at least one plant in the growing chamber contains no infrared light and no ultraviolet light. During the light providing step (f), the method further contemplates the substep of filtering the light to be provided to the at least one plant in the growing chamber so the light that irradiates the at least plant in the growing chamber contains no infrared light and no ultraviolet light. During the filtered plant light irradiating substep, the light irradiating the at least one plant in the growing chamber contains only visible light. The infrared and ultraviolet light filtering is performed using an infrared and ultraviolet light filtering material that is configured to allow passage therethrough of light having wavelengths between infrared and ultraviolet light. In a preferred embodiment, the infrared and ultraviolet light filtering material is composed of an acrylic or includes an acrylic, e.g., an acrylic material.

In one preferred embodiment, the growing atmosphere growing compartment is at least partially composed of an infrared and ultraviolet light filtering material configured to allow light having wavelengths between infrared and ultraviolet light from a source of plant lighting disposed exteriorly of the growing chamber to pass therethrough into the growing atmosphere holding compartment and irradiate the shoot system of the at least one plant in the growing chamber. In another preferred embodiment, the shoot system is irradiated with light from a source of light disposed exteriorly of the growing chamber delivered to the shoot system of the at least one plant in the growing chamber via a light transmitting cable or conduit. In one such preferred embodiment, the source of light is the sun and the sunlight is filtered to block passage of infrared and ultraviolet light through a fiber optic cable light transmitter that delivers the filtered light to the growing atmosphere holding compartment where the filtered light irradiates the shoot system of each plant in the growing chamber thereby providing light for photosynthesis.

In a preferred method implementation and embodiment, the arrangement configured for dissolving oxygen into the aqueous liquid growing medium in the aqueous liquid growing medium holding tank saturates the aqueous liquid growing medium with oxygen during the oxygenating step. In one such method implementation and embodiment, at least 33%, preferably at least 66%, more preferably at least 75%, even more preferably at least 85%, still even more preferably at least 90%, and even more preferably at least 95% of the root system of the at least one plant in the growing chamber is immersed in the oxygen-saturated aqueous liquid growing medium in the aqueous liquid growing medium holding tank. In one such method implementation and embodiment, the entire root system of the at least one plant in the growing chamber is substantially completely immersed in the oxygen-saturated aqueous liquid growing medium in the aqueous liquid growing medium holding tank. In one method implementation and embodiment, the aqueous liquid growing medium in the aqueous liquid growing medium holding tank is substantially completely composed of water prior to the oxygenating step.

In a preferred method implementation and embodiment, the arrangement configured for dissolving oxygen into the aqueous liquid growing medium in the aqueous liquid growing medium holding tank supersaturates the aqueous liquid growing medium with oxygen during the oxygenating step. Nebulization preferably is used during the oxygenating step to dissolve oxygen into the aqueous liquid growing medium in the aqueous liquid growing medium holding tank. Nebulization preferably is used during the oxygenating step to nebulize oxygen into nanosized bubbles introduced into the aqueous liquid growing medium in the aqueous liquid growing medium holding tank. A nebulizer, that preferably is a charged nebulizer comprised of glass, is used to form nanosized oxygen bubbles from pressurized oxygen. During oxygen nebulization, oxygen having a pressure of at least 20 PSI, preferably at least 40 PSI, more preferably 60 PSI, even more preferably 80 PSI, and still even more preferably 100 PSI is nebulized to form the nanosized oxygen bubbles. During oxygen nebulization, the oxygen is substantially completely pure oxygen.

A charged nebulizer preferably is used to form charged nanosized oxygen bubbles from pressurized oxygen that stay in solution in the aqueous liquid growing medium for at least one week after being dissolved in the aqueous liquid growing medium. Such a charged nebulizer preferably is used to form charged nanosized oxygen bubbles from pressurized oxygen that stay in solution in the aqueous liquid growing medium for at least two weeks after being dissolved in the aqueous liquid growing medium. Such a charged nebulizer preferably is used to form charged nanosized oxygen bubbles from pressurized oxygen that stay in solution in the aqueous liquid growing medium for at least three weeks after being dissolved in the aqueous liquid growing medium. Such a charged nebulizer preferably is used to form charged nanosized oxygen bubbles from pressurized oxygen that stay in solution in the aqueous liquid growing medium for at least four weeks after being dissolved in the aqueous liquid growing medium.

In a preferred method implementation and embodiment, the plant growing chamber is disposed inside a building or preferably underground. In one such preferred method implementation and embodiment, the plant growing chamber is disposed underground at a depth deep enough to provide a substantially constant growing temperature within the plant growing chamber. In one preferred method implementation and embodiment, the plant growing chamber is disposed underground in a desert. The underground growing chamber generally overlics an underground aquifer, e.g., underground lake, in the desert, the aqueous liquid growing medium is composed of or includes water from the underground aquifer. In one such preferred method implementation and embodiment, the aqueous liquid growing medium is an aqueous hydroponics liquid growing medium that is composed substantially completely of water, e.g., initially distilled or purified water before any nutrients, e.g., fertilizer(s), are added thereto.

The present invention also is directed to a system for growing plants that includes (a) a growing chamber having (1) a growing atmosphere holding compartment holding a growing atmosphere, and (2) an aqueous liquid growing medium holding tank holding an aqueous liquid growing medium, (b) an arrangement configured for stomatal plant feeding of at least one nutrient delivered to stomata of a shoot system of a plant being grown in the growing chamber, (c) an arrangement configured for oxygenating the aqueous liquid growing medium in the aqueous liquid growing medium holding tank, and (d) a source of plant lighting. The present invention further contemplates an arrangement for auditorily stimulating plant growth through the use of one or more transducers, e.g. loudspeakers, in operable cooperation with the growing atmosphere holding compartment which emit vibration, e.g. sound, at frequencies optimal for stimulating plant growth, preferably shoot growth of plants being grown in the growing chamber of the present invention. If desired, the transducers can be disposed within the growing chamber and/or in contact with part of the structure of the growing chamber, such as portion of a wall or panel which makes up part of the growing atmosphere holding compartment of the growing chamber.

During growing chamber operation, the growing atmosphere in the growing atmosphere holding compartment is pressurized to a plurality of times of the earth's atmospheric pressure. A preferred embodiment, the growing atmosphere in the growing atmosphere holding compartment is pressurized to a plurality of pairs of, i.e., at least three, times of the earth's atmospheric pressure. The growing atmosphere in the growing atmosphere holding compartment preferably is composed of an enhanced carbon dioxide growing atmosphere having a level of carbon dioxide greater than the level of carbon dioxide in the earth's atmosphere. In one preferred embodiment, the growing atmosphere in the growing atmosphere holding compartment contains at least 0.05% carbon dioxide by volume, preferably contains at least 0.06% carbon dioxide, more preferably contains at least 0.075% carbon dioxide, even more preferably contains at least 800 parts per billion carbon dioxide, still even more preferably contains at least 0.09% carbon dioxide, and yet still even more preferably contains at least 0.1% carbon dioxide. In a preferred embodiment, the growing atmosphere in the growing atmosphere holding compartment is composed substantially completely of carbon dioxide. As previously noted, during this time the enhanced or increased carbon dioxide growing atmosphere in the growing atmosphere holding compartment is pressurized to a chamber pressure that is at least a plurality of times the earth's atmospheric pressure and preferably is pressurized to a pressure that is a plurality of pairs of times the earth's atmospheric pressure.

In another preferred embodiment, the growing atmosphere in the growing atmosphere holding compartment contains at least 5% by volume of carbon dioxide, preferably contains at least at least 10% by volume carbon dioxide, more preferably contains at least at least 15% by volume carbon dioxide, even more preferably contains at least at least 20% by volume carbon dioxide, still even more preferably contains at least at least 25% by volume carbon dioxide, yet still even more preferably contains at least at least 35% by volume carbon dioxide, still even more preferably contains at least at least 50% by volume carbon dioxide, still even more preferably contains at least at least 60% by volume carbon dioxide, still even more preferably contains at least at least 75% by volume carbon dioxide, still even more preferably contains at least at least 80% by volume carbon dioxide, and still even more preferably contains at least at least 90% by volume carbon dioxide. In a preferred embodiment, the growing atmosphere in the growing atmosphere holding compartment is composed substantially completely of carbon dioxide. As previously noted, during this time the enhanced or increased carbon dioxide growing atmosphere in the growing atmosphere holding compartment is pressurized to a chamber pressure that is at least a plurality of times the earth's atmospheric pressure and preferably is pressurized to a pressure that is a plurality of pairs of times the earth's atmospheric pressure.

In a preferred embodiment, the arrangement configured for stomatal plant feeding is or includes a nebulizer configured for nebulizing liquid fertilizer containing at least one plant nutrient and a surfactant discharging droplets from the nozzle of the nebulizer that are surfactant-enhanced liquid fertilizer droplets that are more easily and quickly taken up through the stomata of foliage of the plant being fertilized thereby. The droplets preferably are nanosized for further increasing stomatal uptake and can be charged, such as preferably electrostatically charged where the nebulizer is a charged nebulizer or electrostatic nebulizer to more cause the charged droplets to more rapidly be attracted to and wet the foliage increasing the rate of feeding while advantageously minimizing the amount of fertilizer that is lost because it did not make contact with the foliage.

The arrangement configured for oxygenating the aqueous liquid growing medium in the aqueous liquid growing medium holding tank comprises (a) a nebulizer configured for nebulizing pressurized oxygen and forming nanosized bubbles composed of oxygen that are introduced into the aqueous liquid growing medium oxygenating the aqueous liquid growing medium, and (b) a source of pressurized oxygen nebulized by the nebulizer. In a preferred embodiment, the arrangement configured for oxygenating the aqueous liquid growing medium in the aqueous liquid growing medium holding tank is or includes (a) a charged nebulizer configured for nebulizing pressurized oxygen and forming charged nanosized bubbles composed of oxygen introduced into the aqueous liquid growing medium oxygenating the aqueous liquid growing medium, and (b) a source of pressurized oxygen nebulized by the charged nebulizer. Preferably, oxygen from nebulizing oxygenation of the aqueous liquid growing medium in the aqueous liquid growing medium holding tank using the charged nebulizer stays in solution in the aqueous liquid growing medium for at least one week, preferably for at least two weeks, more preferably for at least three weeks, and even more preferably for at least four weeks after being dissolved in the aqueous liquid growing medium. The pressurized oxygen that is nebulized using the nebulizer, preferably charged nebulizer, has a pressure of at least 20 PSI, preferably at least 30 PSI, more preferably at least 40 PSI, even more preferably at least 60 PSI, yet even more preferably at least 80 PSI, and even yet more preferably at least 100 PSI, facilitating formation of the nanosized oxygen bubbles. The pressurized oxygen that is nebulized using the charged nebulizer preferably is composed of substantially completely pure oxygen. During this time the enhanced or increased carbon dioxide growing atmosphere in the growing atmosphere holding compartment is pressurized to a chamber pressure that is at least a plurality of times the earth's atmospheric pressure and preferably is pressurized to a pressure that is a plurality of pairs of times the earth's atmospheric pressure.

The present invention is directed to a method and system of growing plants utilizing a closed growing system employing a pressurized growing chamber in which plants are stomatically fed using liquid nutrient nebulization in an enhanced CO2 pressurized growing atmosphere, watered using an oxygen saturated aqueous hydroponic liquid medium, preferably oxygen supersaturated aqueous hydroponic liquid medium without any soil, herbicides, nor pesticides, where oxygenation is achieved using charged nebulization of pressurized oxygen to form nanosized oxygen-containing and/or oxygen-carrying bubbles, with light provided for photosynthesis that is filtered of cell-damaging infrared and DNA-damaging ultraviolet rays. The CO2 can be and preferably is provided from a CO2 capture and/or sequestration system which can be configured to capture or obtain CO2 from air outside the growing chamber. In a preferred method and system, the growing chamber is indoors, such as preferably underground, with light for photosynthesis provided using a light-transmitting conduit, a light pipe and/or optical fiber(s), e.g., fiber optic cable, to transmit or convey outdoor light, such as from the sun, to the growing chamber to irradiate each plant in the growing chamber. In one such preferred method and system, the light is filtered using at least one and preferably both an infrared light filter and an ultraviolet light filter to deliver intermediate visible light wavelengths to the plants in the chamber. Such a system and method of the invention advantageously speeds up germination, increases the rate and amount of shoot growth, increases the rate and amount of root growth, shortens the time required until yield and harvest, and/or increases the amount of yield and the amount of time the plants produce a yield, with it producing (i) common beans at least five times and preferably at least seven times the size of common beans grown outdoors in natural sunlight using soil, and (ii) tomatoes at least five times and preferably at least seven times the size of tomatoes of the same kind or variety grown outdoors in natural sunlight using soil. A method and system of growing plants in accordance with the present invention advantageously is carbon neutral, preferably carbon negative, and advantageously is scalable thereby enabling a plurality of pairs, i.e., at least three, of the growing chambers, preferably dozens or even hundreds of the growing chambers to collectively operate as a farm.

The present invention also is directed to plant growing system having an acoustic stimulator where the acoustic stimulator is configured to acoustically stimulate at least one plant while it is growing in the growing chamber with acoustical energy with a tone or sound having a frequency that initially starts in one embodiment and configuration at about 500 Hz and increases over time, such as preferably substantially linearly, to a frequency of about 6000 Hz before repeating, preferably a plurality of times separated by a dwell period of a plurality of minutes where the at least one plant is not stimulated with any acoustic energy, sound or tone. In another embodiment and configured, the at least one plant is stimulated with acoustical energy, such as in the form of a tone or sound that increases, preferably generally linearly over time, from about 4000 Hz to about 6000 Hz before repeating. In a further embodiment and method, the acoustic stimulator is configured to acoustically stimulate the at least one plant while it is growing in the growing chamber with acoustical energy having a frequency that initially starts at about 500 Hz and increases over time to about 6000 Hz in one method and initially starts at about 4000 Hz and increases over time to about 6000 Hz in another method, ceasing acoustical stimulation by stopping the acoustical energy for a period of time that preferably is predetermined and which preferably is at least one minute, and then repeating the steps of acoustically stimulating the at least one plant with the acoustical energy having the frequency that initially starts at about 500 Hz and increases over time to about 6000 Hz in one method and initially starts at about 4000 Hz and increases over time to about 6000 Hz in another method and thereafter ceasing acoustical stimulation by stopping the acoustical energy for a period of time. Such acoustical stimulation in accordance with that discussed hereinabove stimulates the plants in the growing chamber being subjected to acoustical stimulation to open pores of stomata of foliage of the stimulated plants. In one preferred method, as the frequency increases from about 500 Hz to about 6000 Hz it causes the stimulated plants to corresponding increasingly open pores of stomata of their foliage. During acoustical stimulation, the at least one plant preferably is stimulated with acoustical energy, including at one or more of the aforementioned frequencies and before frequencies extending between the aforementioned frequencies of between 50 dB and 110 db, preferably between 60 dB and 100 dB, and more preferably between about 70 dB and about 90 dB.

Understandably, the present invention has been described above in terms of one or more preferred embodiments and methods. It is recognized that various alternatives and modifications can be made to these embodiments and methods that are within the scope of the present invention. It is also to be understood that, although the foregoing description and drawings describe and illustrate in detail one or more preferred embodiments of the present invention, to those skilled in the art to which the present invention relates, the present disclosure will suggest many modifications and constructions as well as widely differing embodiments and applications without thereby departing from the spirit and scope of the invention.

What is claimed is:

1. A system for growing at least one plant having a root system and a shoot system comprised of foliage and stomata, the plant growing system comprising:
(a) a plant growing chamber comprised of (1) a growing atmosphere, and (2) a growing medium, the plant growing chamber configured to (i) grow at least one plant therewithin, (ii) dispose the shoot system of the at least one plant in the growing atmosphere, and (iii) dispose the root system of the at least one plant in the growing medium;
(b) a compound delivery subsystem configured for delivering one or more compounds to the at least one plant disposed in the plant growing chamber; and
(c) an oxygenation subsystem configured for oxygenating the growing medium.

2. The plant growing system of claim 1, wherein the growing atmosphere in the chamber has a pressure of at least 300 Kpa and further comprising a barrier disposed between the growing atmosphere and the growing medium, the barrier is gas impermeable to prevent gas in the growing atmosphere from diffusing into or going into solution in the growing medium.

3. The plant growing system of claim 2, wherein the barrier is comprised of a gas impermeable membrane that floats on the surface of the growing medium.

4. The plant growing system of claim 1, further comprising an acoustic stimulator configured to acoustically stimulate the at least one plant while it is growing in the growing chamber with acoustical energy having a frequency of that initially starts at about 500 Hz and increases over time to about 6000 Hz stimulating the at least one plant to increasingly open pores of stomata of foliage of the at least one plant as the frequency increases from about 500 Hz to about 6000 Hz.

5. The plant growing system of claim 4, wherein the acoustic stimulator is configured to acoustically stimulate the at least one plant while it is growing in the growing chamber with acoustical energy where the frequency generally linearly increases over time from at least about 500 Hz to about 6000 Hz for a period of about 10 minutes, ceases stimulating the at least one plant with acoustical energy for a predetermined period of time, and thereafter repeating the acoustically stimulation of the at least one plant while it is growing in the growing chamber with acoustical energy where the frequency generally linearly increases over time from at least about 500 Hz to about 6000 Hz for another period of about 10 minutes.

6. The plant growing system of claim 4, wherein the growing atmosphere has a pressure of between about 300 kPa and about 600 kPa and contains between 0.06% and 0.40% carbon dioxide by volume.

7. The plant growing system of claim 1, wherein the growing atmosphere has a pressure of at least 150 kPa and contains at least 0.05% carbon dioxide by volume.

8. The plant growing system of claim 7, wherein the growing atmosphere has a pressure of between about 300 kPa and about 600 kPa and contains between 0.06% and 0.40% carbon dioxide by volume.

9. The plant growing system of claim 1, wherein the growing atmosphere consists essentially of carbon dioxide during a ripening or maturation stage of the at least one plant.

10. The plant growing system of claim 1, wherein the growing atmosphere consists essentially of carbon dioxide during a ripening or maturation stage of the at least one plant.

11. The plant growing system of claim 1, wherein the compound delivery subsystem comprises a plant feeding system comprised of an atomizer disposed in the growing atmosphere having a discharge nozzle in the growing atmosphere, a fertilizer comprised of one or more plant nutrients and at least one surfactant, and wherein the growing atmosphere contains droplets of the fertilizer from the atomizer that are taken up by stomata of foliage of the at least one plant to fertilize the at least one plant.

12. The plant growing system of claim 11, wherein the atomizer comprises a charged atomizer or an electrostatic atomizer.

13. The plant growing system of claim 12, wherein the fertilizer droplets are nanosized.

14. The plant growing system of claim 11, wherein the at least one surfactant comprises one of a food grade surfactant and a food safe surfactant.

15. The plant growing system of claim 14, wherein the at least one surfactant comprises at least one of polysorbate 20, sodium dodecyl sulfate, a monoglyceride, a diglyceride, sorbitan monostearate, a sucrose ester, GMS, a PGFA, or SSL,

16. The plant growing system of claim 15, wherein the fertilizer droplets have a size or diameter of between 1 nm and about 100 nm.

17. The plant growing system of claim 11, wherein the fertilizer is comprised of one or more nutrients comprising nitrogen, phosphorous, potassium, magnesium, calcium, sulfur, manganese, copper, zinc, boron, molybdenum, and chlorine.

18. The plant growing system of claim 17, wherein the fertilizer droplets are nanosized.

19. The plant growing system of claim 18, wherein the fertilizer droplets have a size or diameter of between 1 nm and about 100 nm.

20. The plant growing system of claim 11, further comprising an acoustic stimulator configured to acoustically stimulate the at least one plant while it is growing in the growing chamber with acoustical energy having a frequency of that initially starts at about 500 Hz and increases over time to about 6000 Hz stimulating the at least one plant to increasingly open pores of stomata of foliage of the at least one plant as the frequency increases from about 500 Hz to about 6000 Hz facilitating stomatal uptake of the one or more nutrients in the fertilizer droplets by stomata of foliage of the at least one plant.

21. The plant growing system of claim 20, wherein the fertilizer droplets are nanosized.

22. The plant growing system of claim 21, wherein the fertilizer droplets are electrostatically charged.

23. The plant growing system of claim 1, wherein the growing medium comprises an oxygenated growing medium that contains at least 2 mg/L oxygen.

24. The plant growing system of claim 23, wherein the oxygen is comprised of oxygen bubbles dissolved in the growing medium.

25. The plant growing system of claim 24, wherein the oxygen bubbles comprised nanosized oxygen bubbles.

26. The plant growing system of claim 25, wherein the nanosized oxygen bubbles have a diameter of between 1 nm and about 150 nm.

27. The plant growing system of claim 1, wherein the oxygenation subsystem comprises (a) a source of pressurized oxygen, (b) a source of a growing medium makeup liquid comprised of water, and (e) an oxygenated growing medium makeup liquid collection tank containing (i) oxygenated growing medium makeup liquid and (ii) a gaseous atmosphere containing oxygen.

28. The plant growing system of claim 27, wherein the oxygen-containing atmosphere in the oxygenated growing medium makeup liquid collection tank has a pressure of at least 250 PSI and the oxygenated growing medium makeup liquid in the oxygenated growing medium makeup liquid collection tank has a temperature of between about 18° C. and about 24° C. for increasing the solubility of the oxygenated growing medium makeup liquid to cause oxygen from the oxygen-containing atmosphere to dissolved or diffuse thereinto increasing the oxygenation thereof.

29. The plant growing system of claim 27, further comprising an atomizer that mixes the pressurized oxygen with the growing medium makeup liquid and discharges the mixture in the form of droplets of oxygenated growing medium makeup liquid containing oxygen dissolved or diffused therein during mixing.

30. The plant growing system of claim 29, wherein the droplets discharged from the atomizer comprise at least one oxygen bubble diffused or dissolved therein.

31. The plant growing system of claim 30, wherein the at least one oxygen bubble diffused or dissolved in the droplets comprises a nanosized oxygen bubble.

32. The plant growing system of claim 31, wherein the droplets discharged from the atomizer comprise nanosized droplets.

33. The plant growing system of claim 32, wherein the atomizer comprises a charged atomizer or an electrostatic atomizer.

34. The plant growing system of claim 33, wherein the atomizer comprises a nebulizer.

35. The plant growing system of claim 1, wherein the oxygenation subsystem is comprised of an electrolyzer having an anode and a cathode electrically charged during electrolysis, and electrolyte comprised of water received in the electrolyzer in which the anode and cathode are immersed from which oxygen gas separated from the electrolyte by one of the anode and cathode forms bubbles on one of the anode and the cathode that dissolve or diffuse into the electrolyte forming an electrolyzer oxygenated growing medium makeup liquid, and wherein the growing medium is comprised of the electrolyzer oxygenated growing medium makeup liquid.

36. The plant growing system of claim 35, wherein one of the electrically charged anode and cathode separates oxygen gas from the electrolyte that is thereafter collected, and wherein electrolyzer oxygenated growing medium makeup liquid is comprised of the collected oxygen gas.

37. The plant growing system of claim 36, wherein the collected oxygen comprises pressurized oxygen and the oxygenation subsystem further comprises an atomizer that mixes the pressurized oxygen with the electrolyzer oxygenated growing medium makeup liquid and discharges the mixture in the form of droplets of oxygenated growing medium makeup liquid containing oxygen from the pressurized oxygen dissolved or diffused therein.

38. The plant growing system of claim 37, wherein the oxygenation subsystem further comprises an oxygenated growing medium makeup liquid collection tank that receives the droplets of the oxygenated growing medium makeup liquid discharged from the atomizer that forms a pool of the oxygenated growing medium makeup liquid in the collection tank, the collection tank holding a gaseous atmosphere comprised of oxygen gas, and wherein the growing medium is comprised of oxygenated growing medium makeup liquid from the collection tank.

39. The plant growing system of claim 38, wherein the growing medium comprised of oxygenated growing medium makeup liquid from the collection tank contains at least 2 mg/L oxygen.

40. The plant growing system of claim 38, wherein the droplets discharged from the atomizer comprise at least one oxygen bubble diffused or dissolved therein.

41. The plant growing system of claim 40, wherein the at least one oxygen bubble diffused or dissolved in the droplets comprises a nanosized oxygen bubble.

42. The plant growing system of claim 35, wherein one of the electrically charged anode and cathode separates oxygen gas from the electrolyte that is thereafter collected, and wherein the collected oxygen gas is diffused or dissolved into the electrolyzer oxygenated growing medium makeup liquid forming an oxygenated growing medium makeup liquid containing an amount of oxygen therein that is greater than an amount of oxygen containing in the electrolyzer oxygenated growing medium makeup liquid.

43. The plant growing system of claim 42, wherein the oxygenation subsystem further comprises an atomizer that diffuses or dissolves the collected oxygen gas into the electrolyzer oxygen growing medium makeup liquid into discharged droplets comprising the electrolyzer oxygenated growing medium makeup liquid, and wherein the growing medium is comprised of the electrolyzer oxygenated growing medium makeup liquid and contains at least 4 mg/L oxygen.

44. The plant growing system of claim 42, wherein the oxygenation subsystem further comprises a nebulizer that diffuses or dissolves the collected oxygen gas into the electrolyzer oxygen growing medium makeup liquid into discharge nanosized droplets comprising the electrolyzer oxygenated growing medium makeup liquid, and wherein the growing medium is comprised of the electrolyzer oxygenated growing medium makeup liquid and contains at least 4 mg/L oxygen
